(19) United States
(12) Patent Application Publication
(10) Pub. No.: US 2012/0106404 A1
(43) Pub. Date: May 3, 2012

(54) FDD AND TDD CARRIER AGGREGATION

(75) Inventor: Jelena M. Damnjanovic, Del Mar, CA (US)

(73) Assignee: QUALCOMM Incorporated, San Diego, CA (US)

(21) Appl. No.: 13/286,209

(22) Filed: Oct. 31, 2011

Related U.S. Application Data
(60) Provisional application No. 61/409,094, filed on Nov. 1, 2010.

(51) Int. Cl. H04W 72/04; H04J 3/00; H04B 7/14; H04J 1/00

(52) U.S. Cl. 370/279; 370/329; 370/281; 370/280; 370/315

(57) ABSTRACT

In a first configuration, a first BS communicates with a first UE through at least one CC. The first BS determines whether to aggregate the at least one CC with at least one additional CC for communication with the first UE based on an interference caused to a second BS and/or a second UE. The at least one additional CC is used by the second BS to communicate with the second UE. In a second configuration, an BS communicates with a first UE and a second UE through at least one CC. The BS determines whether to aggregate the at least one CC and at least one additional CC for communication with the second UE based on an interference caused to the first UE and/or a third UE. The at least one additional CC is used by the first UE to relay information between the third UE and the BS.

### CROSS-REFERENCE TO RELATED APPLICATION(S)

This application claims the benefit of U.S. Provisional Application Ser. No. 61/409,094, entitled “FDD TDD CARRIER AGGREGATION” and filed on Nov. 1, 2010, which is expressly incorporated by reference herein in its entirety.

### BACKGROUND

1. Field

Aspects of the present disclosure relate generally to wireless communication systems, and more particularly, to frequency division duplex (FDD) and time division duplex (TDD) carrier aggregation.

2. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations/evolved Node Bs (eNBs) that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

In view of the increasing demands on the wireless bandwidth, additional techniques to provide additional data communication bandwidth in the available spectrum and/or extending range of wireless communication is desirable.

### SUMMARY

In an aspect of the disclosure, a method, a computer program product, and an apparatus are provided. The apparatus, which may be a BS/eNB, communicates with a first UE through at least one component carrier. In addition, the apparatus determines whether to aggregate the at least one component carrier with at least one additional component carrier for communication with the first UE based on an interference caused to at least one of a second BS or a second UE. The at least one additional component carrier is used by the second BS to communicate with the second UE.

In one configuration, the at least one component carrier includes an FDD uplink carrier and an FDD downlink carrier, and the at least one additional component carrier includes at least one FDD carrier. In one configuration, the apparatus aggregates the at least one component carrier with the at least one additional component carrier by aggregating the FDD uplink carrier and a second FDD uplink carrier for communication on an uplink. In such a configuration, the at least one FDD carrier includes the second FDD uplink carrier. In one configuration, the apparatus aggregates the FDD downlink carrier with the aggregated FDD uplink carrier and the second FDD uplink carrier. In one configuration, the apparatus aggregates the at least one component carrier with the at least one additional component carrier by aggregating the FDD downlink carrier and a second FDD downlink carrier for communication on a downlink. In such a configuration, the at least one FDD carrier includes the second FDD downlink carrier. In one configuration, the apparatus aggregates the FDD uplink carrier with the aggregated FDD downlink carrier and the second FDD downlink carrier.

In one configuration, the at least one component carrier includes an FDD uplink carrier and an FDD downlink carrier, and the at least one additional component carrier includes a TDD carrier. In one configuration, the apparatus aggregates the at least one component carrier with the at least one additional component carrier by aggregating the FDD uplink carrier and uplink subframes of the TDD carrier for communication on an uplink. In one configuration, the apparatus aggregates the FDD downlink carrier with the aggregated FDD uplink carrier and the uplink subframes of the TDD carrier. In one configuration, the apparatus aggregates the at least one component carrier with the at least one additional component carrier by aggregating the FDD downlink carrier and downlink subframes of the TDD carrier for communication on a downlink. In one configuration, the apparatus aggregates the FDD uplink carrier with the aggregated FDD downlink carrier and the downlink subframes of the TDD carrier.

In one configuration, the at least one component carrier includes a TDD carrier including uplink subframes and downlink subframes and the at least one additional component carrier includes at least one FDD carrier. In one configuration, the apparatus aggregates the at least one component carrier with the at least one additional component carrier by aggregating the uplink subframes of the TDD carrier and an FDD uplink carrier for communication on an uplink. In such a configuration, the at least one FDD carrier includes the FDD uplink carrier. In one configuration, the apparatus aggregates the downlink subframes and the uplink subframes of the TDD carrier with the FDD uplink carrier. In one configuration, the apparatus aggregates the at least one component carrier with the at least one additional component carrier by aggregating the downlink subframes of the TDD carrier and an FDD downlink carrier for communication on a downlink. In such a configuration, the at least one FDD carrier includes the FDD downlink carrier. In one configuration, the apparatus aggregates the uplink subframes and the downlink subframes of the TDD carrier with the FDD downlink carrier.

In one configuration, the at least one component carrier includes a first TDD carrier including first TDD uplink subframes and first TDD downlink subframes and the at least one additional component carrier includes a second TDD carrier including second TDD uplink subframes and second TDD downlink subframes. In one configuration, the apparatus aggregates the at least one component carrier with the at least one additional component carrier by aggregating the first TDD uplink subframes and the second TDD uplink subframes for communication on an uplink. In one configuration, the apparatus aggregates the first TDD uplink subframes and the first TDD downlink subframes with the second TDD uplink subframes. In one configuration, the apparatus aggregates the at least one component carrier with the at least one additional component carrier by aggregating the first TDD downlink subframes and the second TDD downlink subframes for communication on a downlink. In one configuration, the apparatus aggregates the first TDD uplink subframes and the first TDD downlink subframes with the second TDD downlink subframes. In one configuration, the first TDD carrier and the second TDD carrier have different subframe uplink and downlink configurations.

In one configuration, the apparatus determines not to aggregate the at least on component carrier and the at least one additional component carrier for communication with the first UE when communication by the first UE on an uplink through the at least one additional component carrier causes interference to the second BS that is greater than a first interference threshold or communication by the first BS on a downlink through the at least one additional component carrier causes interference to the second UE that is greater than a second interference threshold. In one configuration, the apparatus determines whether to communicate unidirectionally or bidirectionally with the first UE through the at least one additional component carrier. In one configuration, the apparatus aggregates the at least one component carrier and the at least one additional component carrier for unidirectional communication with the first UE on an uplink when the communication by the first UE on the uplink through the at least one additional component carrier causes interference to the second BS that is less than a first interference threshold and communication by the first BS on a downlink through the at least one additional component carrier causes interference to the second UE that is greater than a second interference threshold. In one configuration, the apparatus aggregates the at least one component carrier and the at least one additional component carrier for unidirectional communication with the first UE on a downlink when the communication by the first UE on an uplink through the at least one additional component carrier causes interference to the second BS that is greater than a first interference threshold and the communication by the first BS on the downlink through the at least one additional component carrier causes interference to the second UE that is less than a second interference threshold. In one configuration, the apparatus aggregates the at least one component carrier and the at least one additional component carrier for bidirectional communication with the first UE on an uplink and a downlink when the communication by the first UE on the uplink through the at least one additional component carrier causes interference to the second BS that is less than a first interference threshold and the communication by the first BS on the downlink through the at least one additional component carrier causes interference to the second UE that is less than a second interference threshold.

In an aspect of the disclosure, a method, a computer program product, and an apparatus are provided. The apparatus, which may be a UE, receives downlink communication from a BS in downlink through at least one component carrier. The apparatus relays the downlink communication to a UE in downlink resources of at least one additional component carrier. The apparatus receives uplink communication from the UE in uplink resources of the at least one additional component carrier. The apparatus relays the uplink communication to the BS in uplink through the at least one component carrier.

In one configuration, the apparatus receives a relay activation from the BS. The activation is based on at least one of a proximity detection between the UE and the apparatus, an existing peer-to-peer communication between the UE and the apparatus, or channel conditions of at least one of the UE or the apparatus. In one configuration, the at least one component carrier includes an FDD uplink carrier and an FDD downlink carrier, and the at least one additional component carrier includes a TDD carrier including uplink and downlink subframes; the at least one component carrier includes a first FDD uplink carrier and a first FDD downlink carrier, and the at least one additional component carrier includes a second FDD uplink carrier and a second FDD downlink carrier; the at least one component carrier includes a TDD carrier including uplink and downlink subframes, and the at least one additional component carrier includes an FDD uplink carrier and an FDD downlink carrier; or the at least one component carrier includes a first TDD carrier including uplink and downlink subframes, and the at least one additional component carrier includes a second TDD carrier including uplink and downlink subframes.

In an aspect of the disclosure, a method, a computer program product, and an apparatus are provided. The apparatus, which may be a BS/eNB, communicates with a first UE through at least one component carrier. The apparatus communicates with a second UE through the at least one component carrier. The apparatus determines whether to aggregate the at least one component carrier and at least one additional component carrier for communication with the second UE based on an interference caused to at least one of the first UE or a third UE. The at least one additional component carrier is used by the first UE to relay information between the third UE and the BS.

In one configuration, the apparatus activates the first UE to act as a relay. In one configuration, the activation of the first UE to act as a relay for communication with the third UE is based on at least one of a proximity detection between the first UE and the third UE, an existing peer-to-peer communication between the first UE and the third UE, or channel conditions of at least one of the first UE or the third UE.

In one configuration, the at least one component carrier includes an FDD uplink carrier and an FDD downlink carrier, and the at least one additional component carrier includes at least one FDD carrier. In one configuration, the apparatus aggregates the at least one component carrier with the at least one additional component carrier by aggregating the FDD uplink carrier and a second FDD uplink carrier for communication on an uplink with the second UE. In such a configuration, the at least one FDD carrier includes the second FDD uplink carrier. In one configuration, the apparatus aggregates the FDD downlink carrier with the aggregated FDD uplink carrier and the second FDD uplink carrier. In one configuration, the apparatus aggregates the at least one component carrier with the at least one additional component carrier by aggregating the FDD downlink carrier and a second FDD downlink carrier for communication on a downlink with the second UE. In such a configuration, the at least one FDD carrier includes the second FDD downlink carrier. In one configuration, the apparatus aggregates the FDD uplink carrier with the aggregated FDD downlink carrier and the second FDD downlink carrier.

In one configuration, the at least one component carrier includes an FDD uplink carrier and an FDD downlink carrier, and the at least one additional component carrier includes a TDD carrier includes uplink subframes and downlink subframes. In one configuration, the apparatus aggregates the at least one component carrier with the at least one additional component carrier by aggregating the FDD uplink carrier and the uplink subframes of the TDD carrier for communication on an uplink with the second UE. In one configuration, the apparatus aggregates the FDD downlink carrier with the aggregated FDD uplink carrier and the uplink subframes of the TDD carrier. In one configuration, the apparatus aggregates the at least one component carrier with the at least one additional component carrier by aggregating the FDD downlink carrier and the downlink subframes of the TDD carrier for communication on a downlink with the second UE. In one configuration, the apparatus aggregates the FDD uplink carrier with the aggregated FDD downlink carrier and the downlink subframes of the TDD carrier.

In one configuration, the at least one component carrier includes a TDD carrier including uplink subframes and downlink subframes and the at least one additional component carrier includes at least one FDD carrier. In one configuration, the apparatus aggregates the at least one component carrier with the at least one additional component carrier by aggregating the uplink subframes of the TDD carrier and an FDD uplink carrier for communication on an uplink with the second UE. In such a configuration, the at least one FDD carrier includes the FDD uplink carrier. In one configuration, the apparatus aggregates the downlink subframes and the uplink subframes of the TDD carrier with the FDD uplink carrier. In one configuration, the apparatus aggregates the at least one component carrier with the at least one additional component carrier by aggregating the downlink subframes of the TDD carrier and an FDD downlink carrier for communication on a downlink with the second UE. In such a configuration, the at least one FDD carrier includes the FDD downlink carrier. In one configuration, the apparatus aggregates the uplink subframes and the downlink subframes of the TDD carrier with the FDD downlink carrier.

In one configuration, the at least one component carrier includes a first TDD carrier including first TDD uplink subframes and first TDD downlink subframes, and the at least one additional component carrier includes a second TDD carrier including second TDD uplink subframes and second TDD downlink subframes. In one configuration, the apparatus aggregates the at least one component carrier with the at least one additional component carrier by aggregating the first TDD uplink subframes and the second TDD uplink subframes for communication on an uplink with the second UE. In one configuration, the apparatus aggregates the first TDD uplink subframes and the first TDD downlink subframes with the second TDD uplink subframes. In one configuration, the apparatus aggregates the at least one component carrier with the at least one additional component carrier by aggregating the first TDD downlink subframes and the second TDD downlink subframes for communication on a downlink with the second UE. In one configuration, the apparatus aggregates the first TDD uplink subframes and the first TDD downlink subframes with the second TDD downlink subframes. In one configuration, the first TDD carrier and the second TDD carrier have different subframe uplink and downlink configurations.

In one configuration, the apparatus determines not to aggregate the at least one component carrier and the at least one additional component carrier for communication with the second UE when communication by the second UE on an uplink through the at least one additional component carrier causes interference to the first UE that is greater than a first interference threshold and communication by the BS on a downlink through the at least one additional component carrier causes interference to the third UE that is greater than a second interference threshold. In one configuration, the apparatus determines whether to communicate unidirectionally or bidirectionally with the second UE through the at least one additional component carrier. In one configuration, the apparatus aggregates the at least one component carrier and the at least one additional component carrier for unidirectional communication with the second UE on an uplink when the communication by the second UE on the uplink through the at least one additional component carrier causes interference to the first UE that is less than a first interference threshold and communication by the BS on a downlink through the at least one additional component carrier causes interference to the third UE that is greater than a second interference threshold. In one configuration, the apparatus aggregates the at least one component carrier and the at least one additional component carrier for unidirectional communication with the second UE on a downlink when the communication by the second UE on an uplink through the at least one additional component carrier causes interference to the first UE that is greater than a first interference threshold and the communication by the BS on the downlink through the at least one additional component carrier causes interference to the third UE that is less than a second interference threshold. In one configuration, the apparatus aggregates the at least one component carrier and the at least one additional component carrier for bidirectional communication with the second UE on an uplink and a downlink when the communication by the second UE on the uplink through the at least one additional component carrier causes interference to the first UE that is less than a first interference threshold and the communication by the BS on the downlink through the at least one additional component carrier causes interference to the third UE that is less than a second interference threshold.

In one configuration, the apparatus transmits control information to the third UE through a component carrier. The component carrier is one of the at least one component carrier or a different component carrier. The component carrier is aggregated with the at least one additional component carrier by the third UE. The information relayed by the first UE to the third UE is data from the BS.

### BRIEF DESCRIPTION OF THE DRAWINGS

FIG. 1 is a block diagram conceptually illustrating an example of a telecommunications system.

FIG. 2 is a block diagram conceptually illustrating an example of a downlink frame structure in a telecommunications system.

FIG. 3 is a block diagram conceptually illustrating a design of a base station/evolved Node B (eNB) and a UE configured according to one aspect of the present disclosure.

FIG. 4A discloses a continuous carrier aggregation type.

FIG. 4B discloses a non-continuous carrier aggregation type.

FIG. 4C is a block diagram illustrating a method for controlling radio links in multiple carrier configurations.

FIG. 5 discloses MAC layer data aggregation.

FIG. 6 is a diagram illustrating FDD and TDD carriers.

FIG. 7 is a first diagram for illustrating a method for determining whether to aggregate carriers used by neighboring eNBs.

FIG. 8 is a second diagram for illustrating a method for determining whether to aggregate carriers used by neighboring eNBs.

FIG. 9 is a diagram for illustrating a method for determining whether to aggregate carriers within a relay setting.

FIG. 10 is a flow chart of a method of wireless communication of an eNB.

FIG. 11 is a diagram and table for illustrating when carriers are aggregated with respect to an interference.

FIG. 12 is a flow chart of a method of wireless communication of a UE within a relay setting.

FIG. 13 is a flow chart of a method of wireless communication of an eNB within a relay setting.

FIG. 14 is a diagram and table for illustrating when carriers are aggregated with respect to an interference in a relay setting.

FIG. 15 is a conceptual data flow diagram illustrating the data flow between different modules/means/components in an exemplary eNB apparatus.

FIG. 16 is a conceptual data flow diagram illustrating the data flow between different modules/means/components in an exemplary eNB apparatus.

FIG. 17 is a diagram illustrating an example of a hardware implementation for an eNB apparatus employing a processing system.

FIG. 18 is a conceptual data flow diagram illustrating the data flow between different modules/means/components in an exemplary UE apparatus.

FIG. 19 is a diagram illustrating an example of a hardware implementation for an UE apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

Briefly and in general terms, different carrier aggregation (CA) techniques are presented for TDD-FDD CA in various network settings. For example, CA of FDD/TDD carriers for regular UEs and at the same time TDD spectrum utilization for relaying/P2P communication. A UE may be used as a relay in an eNB and another UE communication. eNB may activate a UE to act as a relay for communication with another UE. Activation may be based on the proximity detection between UEs that may be performed among UEs and/or with eNB assistance. Activation may also be prompted as a result of the P2P communication among UEs. The benefits of the may scheme include being able to use much of LTE Rel-10 framework, being able to perform CA on the eNB-UE link, with extension to TDD-FDD aggregation while performing regular Rel-10 TDD operation on the UE-UE link. In one aspect, the relaying UE may be a high category UE, supporting the relay functionality (or some of it). In one aspect, the proposed method may facilitate improved utilization of the TDD and FDD spectrum, thereby providing wider data bandwidth for eNB-UE communication due to CA. In one aspect, interference on UE-UE communication may be protected. In one aspect, increased coverage may be provided for some UEs. In one aspect, peer-to-peer communication between two UEs, without an intermediate eNB may result in traffic offload. In one aspect, the previously described benefits may be obtained while being backward compatible with LTE Rel-10 deployments.

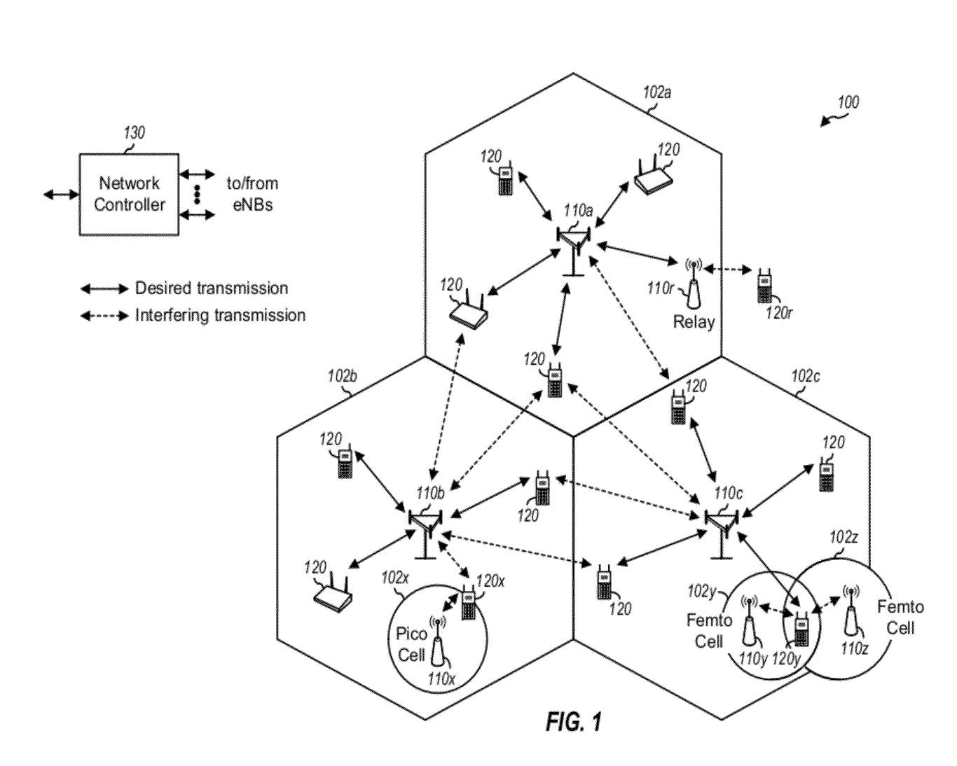

FIG. 1 shows a wireless communication network 100, which may be an LTE network. The wireless network 100 may include a number of evolved Node Bs (eNBs) 110 and other network entities. An eNB may be a station that communicates with the UEs and may also be referred to as a base station, a Node B, an access point, etc. Each eNB 110 may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB. In the example shown in FIG. 1, the eNBs 110a, 110b and 110c may be macro eNBs for the macro cells 102a, 102b and 102c, respectively. The eNB 110x may be a pico eNB for a pico cell 102x. The eNBs 110y and 110z may be femto eNBs for the femto cells 102y and 102z, respectively. An eNB may support one or multiple (e.g., three) cells.

The wireless network 100 may also include relay stations. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 Watts) whereas pico eNBs, femto eNBs and relays may have a lower transmit power level (e.g., 1 Watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, etc. A UE may be able to communicate with macro eNBs, pico eNBs, femto eNBs, relays, etc. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

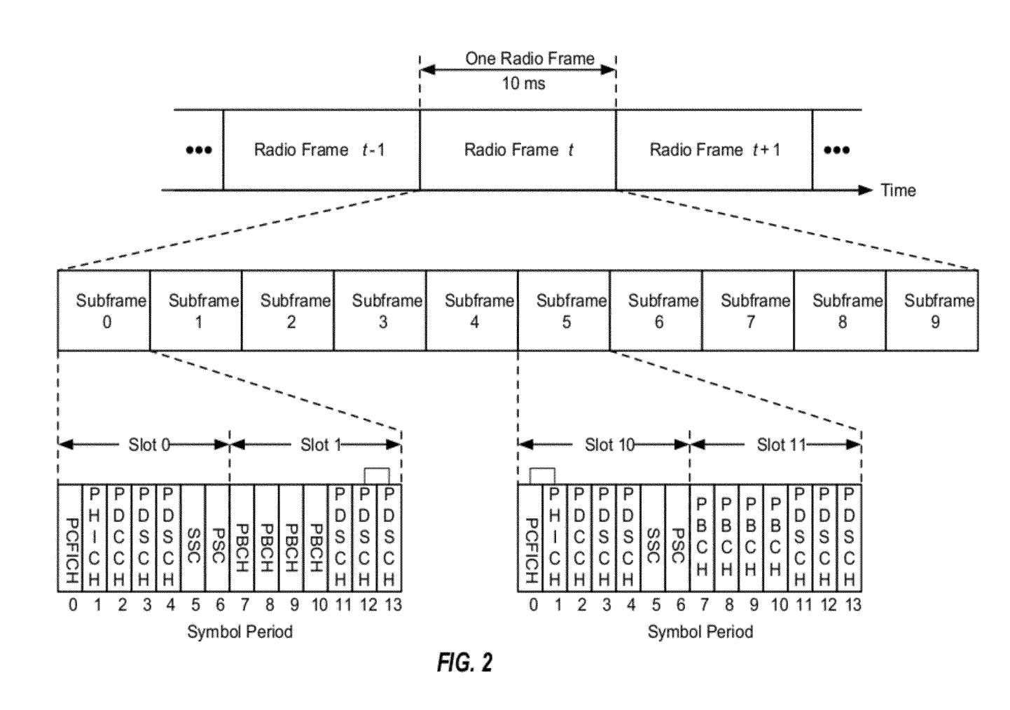

FIG. 2 shows a down link frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 2) or 14 symbol periods for an extended cyclic prefix. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in only a portion of the first symbol period of each subframe, although depicted in the entire first symbol period in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNB may send a Physical HARQ Indicator Channel (PHICH) and a Physical Downlink Control Channel (PDCCH) in the first M symbol periods of each subframe (M=3 in FIG. 2). The PHICH may carry information to support hybrid automatic retransmission (HARQ). The PDCCH may carry information on resource allocation for UEs and control information for downlink channels. Although not shown in the first symbol period in FIG. 2, it is understood that the PDCCH and PHICH are also included in the first symbol period. Similarly, the PHICH and PDCCH are also both in the second and third symbol periods, although not shown that way in FIG. 2. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

A UE may be within the coverage of multiple eNBs. One of these eNBs may be selected to serve the UE. The serving eNB may be selected based on various criteria such as received power, path loss, signal-to-noise ratio (SNR), etc.

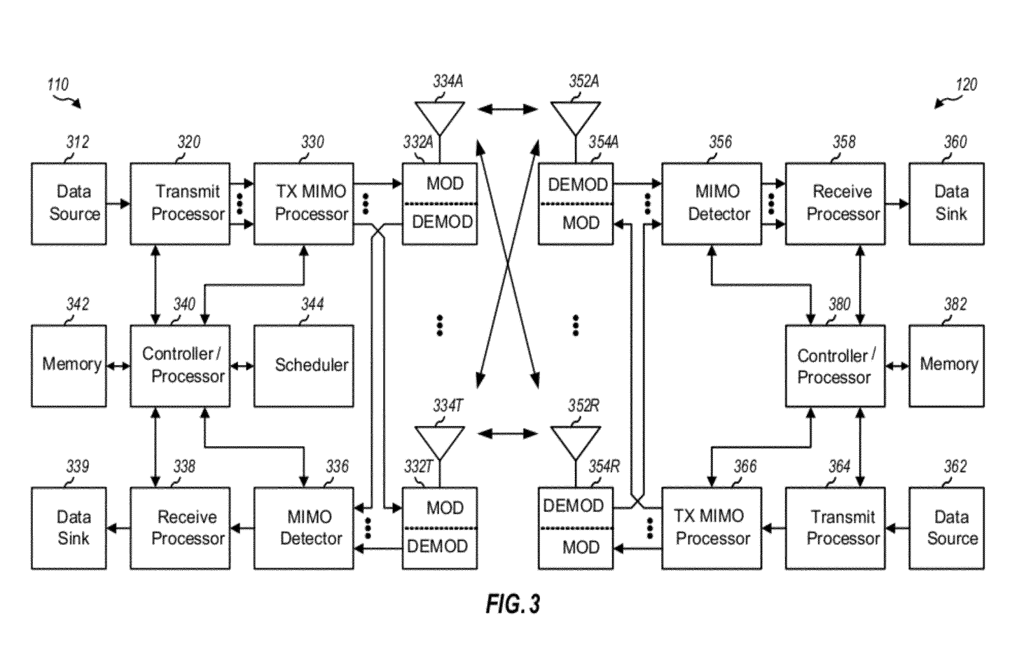

FIG. 3 shows a block diagram of a design of a base station/eNB 110 and a UE 120, which may be one of the base stations/eNBs and one of the UEs in FIG. 1. For a restricted association scenario, the base station 110 may be the macro eNB 110c in FIG. 1, and the UE 120 may be the UE 120y. The base station 110 may also be a base station of some other type. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The processor 364 may also generate reference symbols for a reference signal. The symbols from the transmit processor 364 may be precoded by a TX MIMO processor 366 if applicable, further processed by the demodulators 354a through 354r (e.g., for SC-FDM, etc.), and transmitted to the base station 110. At the base station 110, the uplink signals from the UE 120 may be received by the antennas 334, processed by the modulators 332, detected by a MIMO detector 336 if applicable, and further processed by a receive processor 338 to obtain decoded data and control information sent by the UE 120. The processor 338 may provide the decoded data to a data sink 339 and the decoded control information to the controller/processor 340.

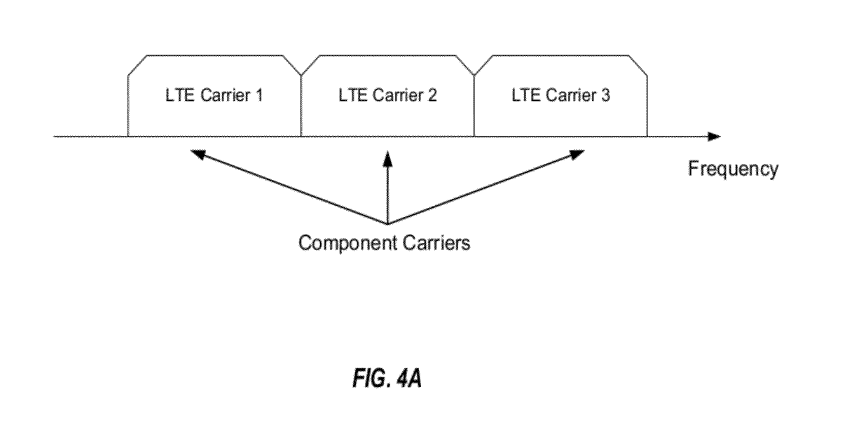

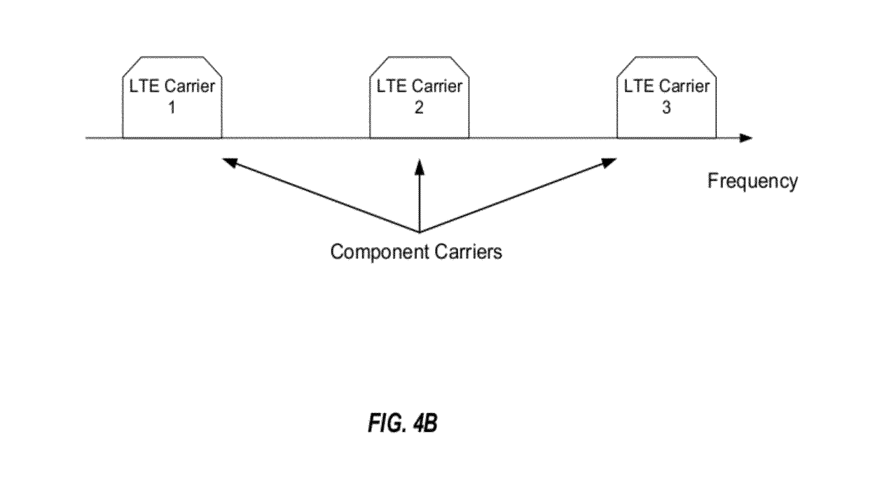

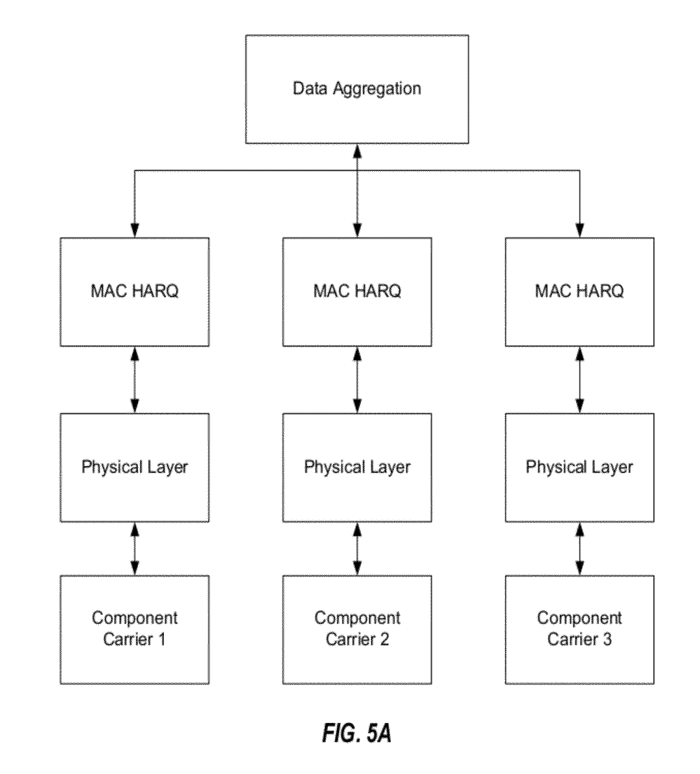

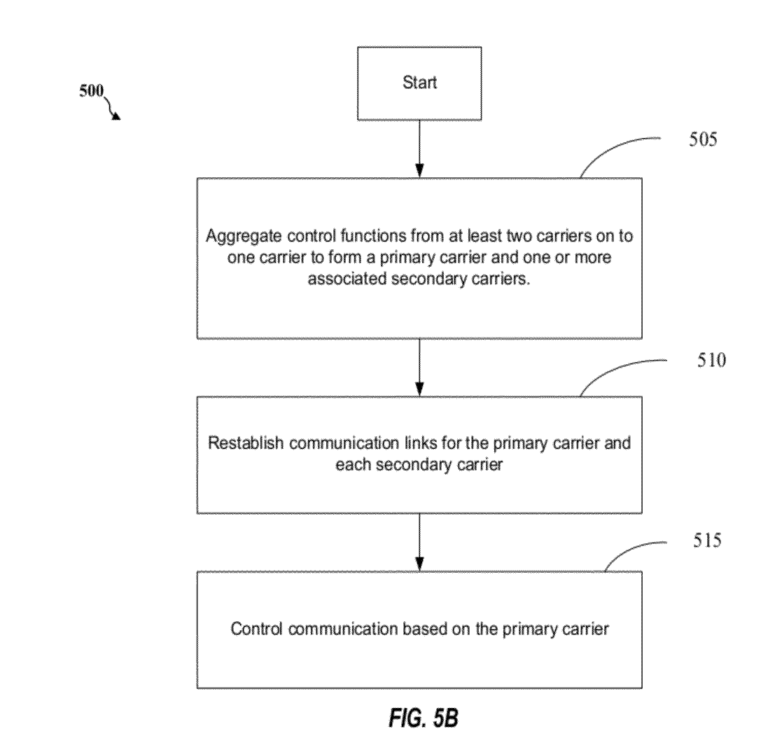

The controllers/processors 340 and 380 may direct the operation at the base station 110 and the UE 120, respectively. The processor 340 and/or other processors and modules at the base station 110 may perform or direct the execution of various processes for the techniques described herein. The processor 380 and/or other processors and modules at the UE 120 may also perform or direct the execution of the functional blocks illustrated in FIGS. 4 and 5, and/or other processes for the techniques described herein. The memories 342 and 382 may store data and program codes for the base station 110 and the UE 120, respectively. A scheduler 344 may schedule UEs for data transmission on the downlink and/or uplink.

In one configuration, the UE 120 for wireless communication includes means for detecting interference from an interfering base station during a connection mode of the UE, means for selecting a yielded resource of the interfering base station, means for obtaining an error rate of a physical downlink control channel on the yielded resource, and means, executable in response to the error rate exceeding a predetermined level, for declaring a radio link failure. In one aspect, the aforementioned means may be the processor(s), the controller/processor 380, the memory 382, the receive processor 358, the MIMO detector 356, the demodulators 354a, and the antennas 352a configured to perform the functions recited by the aforementioned means. In another aspect, the aforementioned means may be a module or any apparatus configured to perform the functions recited by the aforementioned means.

### Carrier Aggregation

LTE-Advanced UEs use spectrum in 20 MHz bandwidths allocated in a carrier aggregation of up to a total of 100 MHz (5 component carriers) used for transmission in each direction. Generally, less traffic is transmitted on the uplink than the downlink, so the uplink spectrum allocation may be smaller than the downlink allocation. For example, if 20 MHz is assigned to the uplink, the downlink may be assigned 100 MHz. These asymmetric FDD assignments will conserve spectrum and are a good fit for the typically asymmetric bandwidth utilization by broadband subscribers.

### Carrier Aggregation Types

For the LTE-Advanced mobile systems, two types of carrier aggregation (CA) methods have been proposed, continuous CA and non-continuous CA. They are illustrated in FIGS. 4A and 4B. Non-continuous CA occurs when multiple available component carriers are separated along the frequency band (FIG. 4B). On the other hand, continuous CA occurs when multiple available component carriers are adjacent to each other (FIG. 4A). Both non-continuous and continuous CA aggregate multiple LTE/component carriers to serve a single unit of LTE Advanced UE.

Multiple RF receiving units and multiple FFTs may be deployed with non-continuous CA in LTE-Advanced UE since the carriers are separated along the frequency band. Because non-continuous CA supports data transmissions over multiple separated carriers across a large frequency range, propagation path loss, Doppler shift and other radio channel characteristics may vary a lot at different frequency bands.

Thus, to support broadband data transmission under the non-continuous CA approach, methods may be used to adaptively adjust coding, modulation and transmission power for different component carriers. For example, in an LTE-Advanced system where the eNB has fixed transmitting power on each component carrier, the effective coverage or supportable modulation and coding of each component carrier may be different.

### Data Aggregation Schemes

FIG. 5A illustrates aggregating transmission blocks (TBs) from different component carriers at the medium access control (MAC) layer for an IMT-Advanced system. With MAC layer data aggregation, each component carrier has its own independent hybrid automatic repeat request (HARQ) entity in the MAC layer and its own transmission configuration parameters (e.g., transmitting power, modulation and coding schemes, and multiple antenna configuration) in the physical layer. Similarly, in the physical layer, one HARQ entity is provided for each component carrier.

FIG. 5B illustrates a method 500 for controlling radio links in a multiple carrier wireless communication system by grouping physical channels according to one example. As shown, the method includes, at block 505, aggregating control functions from at least two carriers onto one carrier to form a primary carrier and one or more associated secondary carriers. Next at block, 510, communication links are established for the primary carrier and each secondary carrier. Then, communication is controlled based on the primary carrier in block 515.

### Control Signaling

In general, there are three different approaches for deploying control channel signaling for multiple component carriers. The first involves a minor modification of the control structure in LTE systems where each component carrier is given its own coded control channel.

The second method involves jointly coding the control channels of different component carriers and deploying the control channels in a dedicated component carrier. The control information for the multiple component carriers will be integrated as the signaling content in this dedicated control channel. As a result, backward compatibility with the control channel structure in LTE systems is maintained, while signaling overhead in the CA is reduced.

Multiple control channels for different component carriers are jointly coded and then transmitted over the entire frequency band formed by a third CA method. This approach offers low signaling overhead and high decoding performance in control channels, at the expense of high power consumption at the UE side. However, this method is not compatible with LTE systems.

### Handover Control

It is preferable to support transmission continuity during the handover procedure across multiple cells when CA is used for IMT-Advanced UE. However, reserving sufficient system resources (i.e., component carriers with good transmission quality) for the incoming UE with specific CA configurations and quality of service (QoS) requirements may be challenging for the next eNB. The reason is that the channel conditions of two (or more) adjacent cells (eNBs) may be different for the specific UE. In one approach, the UE measures the performance of only one component carrier in each adjacent cell. This offers similar measurement delay, complexity, and energy consumption as that in LTE systems. An estimate of the performance of the other component carriers in the corresponding cell may be based on the measurement result of the one component carrier. Based on this estimate, the handover decision and transmission configuration may be determined.

Certain conventional wireless communication standards, such as the current version of LTE Release 10 (Rel-10) allow for aggregation of TDD only or FDD only component carriers (CCs). However, as the demand on wireless bandwidth increases, additional techniques may be needed. Aggregating CCs in the time and/or frequency domains (e.g., FDD or TDD aggregation) may be a technique used to address the increased demand on bandwidth, among others.

In some existing wireless communication deployments, TDD and FDD may be used for communication in a given frequency band. Therefore, aggregation could be performed in the existing wireless communication deployments, either in the frequency domain (in FDD bands) or in the time domain (in the TDD bands). In some proposed designs, aggregation of TDD and FDD CCs offers flexibility in operation not offered by the conventional TDD-only or FDD-only schemes.

In one aspect, wider bandwidth may be made available to UEs 120 (e.g., UEs beyond Rel-10) through combined FDD-TDD aggregation. In some designs, the FDD-TDD aggregation may be performed to be backward compatible with Rel-10 or earlier (Release 8 or 9) systems. Backward compatibility implies that Rel-10 (or earlier releases) equipment may be able to operate in a network alongside equipment implementing FDD-TDD aggregation, with FDD-TDD aggregation being transparent to the Rel-10 equipment.

If FDD and TDD spectrum is available for deployment in a wireless network, it may be beneficial to aggregate communication using combined FDD-TDD schemes disclosed herein. In some designs, Rel-8/9 UEs 120 may also operate on a single FDD or TDD carrier in an FDD-TDD aggregation network. In some designs, Rel-10 UEs 120 may aggregate using FDD-only or TDD-only CCs in an FDD-TDD aggregation network. New UEs 120 that perform FDD-TDD aggregation may aggregate across the whole available spectrum, including FDD and TDD carriers. In one aspect, the combined FDD-TDD aggregation may offer higher peak data rates and more flexible operation of a wireless network. Using certain designs, in heterogeneous networks, it may be possible to perform FDD-TDD aggregation for new Release UEs 120, while preserving backward compatibility for single carrier TDD and FDD UEs 120. For example, in some designs, a TDD carrier may be aggregated with only the uplink (UL) or downlink (DL) part (e.g., subframes) of another TDD carrier (called unidirectional aggregation).

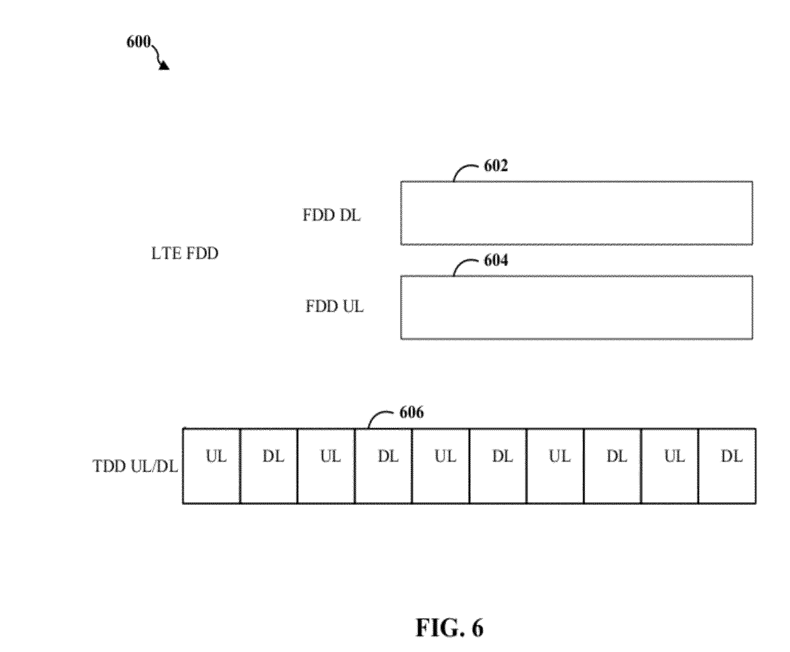

FIG. 6 is a diagram 600 illustrating FDD and TDD carriers. For LTE FDD, bidirectional communication through FDD requires two paired FDD carriers, an FDD DL carrier 602 and an FDD UL carrier 604. Aggregation of one CC with an FDD carrier for DL requires aggregation of the one CC with the FDD DL carrier 602. Aggregation of one CC with an FDD carrier for UL requires aggregation of the one CC with the FDD UL carrier 604. For LTE TDD, bidirectional communication through TDD requires one TDD carrier 606. Aggregation of one CC with a TDD carrier on UL requires aggregation of the one CC with UL subframes of the TDD carrier 606. Aggregation of one CC with a TDD carrier on DL requires aggregation of the one CC with DL subframes of the TDD carrier 606. One frame of the TDD carrier 606 is shown. A frame may be 10 ms and include 10 subframes. The UL and DL subframe allocation may be periodic, repeating in each frame.

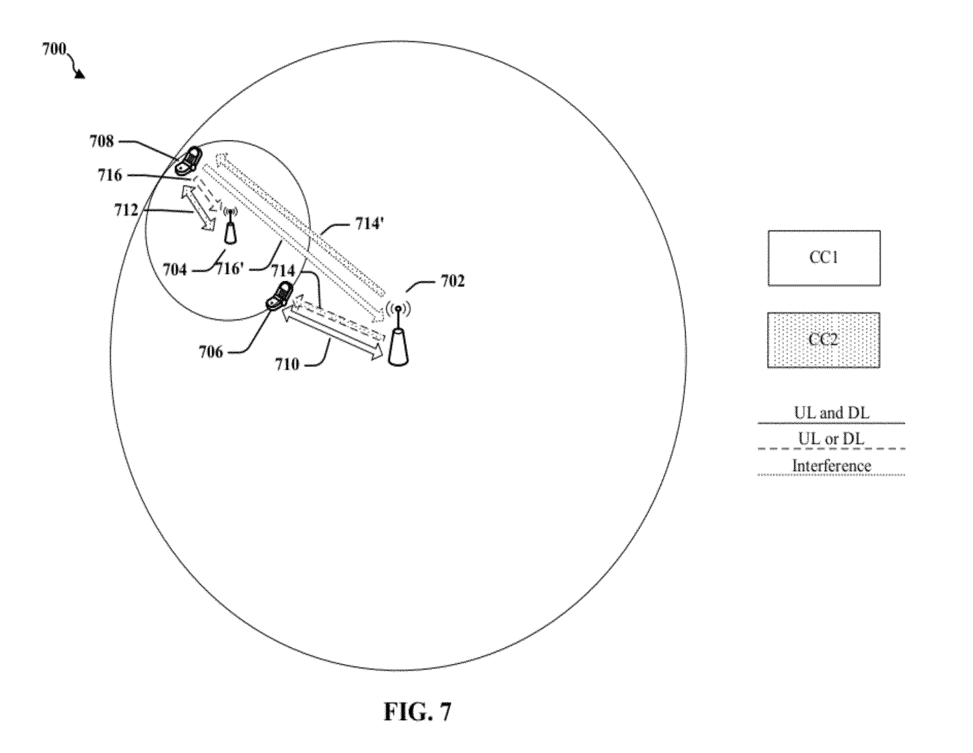

FIG. 7 is a first diagram 700 for illustrating a method for determining whether to aggregate carriers used by neighboring eNBs. As shown in FIG. 7, a CSG 704 is within the cell of the macro eNB 702. The CSG 704 may be a femto, nano, or pico cell, and may be referred to as a remote radio head (RRH). The eNB 702 communicates bidirectionally 710 with the UE 706 through the anchor CC CC1. The CSG 704 communicates bidirectionally 712 with the UE 708 through the anchor CC CC2. If the bidirectional communication 710 is TDD, then the bidirectional communication 710 is through one TDD CC, and if the bidirectional communication 710 is FDD, then the bidirectional communication 710 is through one FDD UL CC and one FDD DL CC. Similarly, if the bidirectional communication 712 is TDD, then the bidirectional communication 712 is through one TDD CC, and if the bidirectional communication 712 is FDD, then the bidirectional communication 712 is through one FDD UL CC and one FDD DL CC.

In FIG. 7, the solid arrows represent bidirectional communication, the long-dashed arrows represent unidirectional communication, and the short-dashed arrows represent interference caused by the use of an aggregated carrier. The UE 706, within the coverage of the CSG 704, may not be able to connect to the CSG due to the restricted access. In order to increase communication bandwidth, the eNB 702 may aggregate the UL and/or DL of CC2 with CC1, but must protect the CC2 so as not to cause too much interference to the CSG 704 and the UE 708. The eNB 702 determines whether to aggregate the UL and/or DL of the CC2 with the CC1 for communication with the UE 706 based on an interference caused to the CSG 704 and the UE 708. If use on DL of the CC2 by the eNB 702 for communication with the UE 706 causes DL interference 714′ to the UE 708 that is less than a threshold, the eNB 702 may aggregate the DL of the CC2 for DL communication 714 with the UE 706. If use on UL of the CC2 by the UE 706 causes UL interference to the CSG 704 that is less than a threshold, the eNB 702 may aggregate the UL of the CC2 for UL communication with the UE 706. As shown in FIG. 7, the eNB 702 determined to aggregate the DL of the CC2 with the CC1 for communication with the UE 706, but not the UL of the CC2 with the CC1 for communication with the UE 706. If the CC1 and the CC2 are TDD, the eNB 702 aggregates the UL and the DL subframes of the TDD CC1 with the DL subframes of the TDD CC2. If the CC1 is TDD and the CC2 is FDD, the eNB 702 aggregates the UL and the DL subframes of the TDD CC1 with the FDD DL CC2. If the CC1 is FDD and the CC2 is TDD, the eNB 702 aggregates the FDD UL CC1 and the FDD DL CC1 with the DL subframes of the TDD CC2. If the CC1 and the CC2 are FDD, the eNB 702 aggregates the FDD UL CC1 and the FDD DL CC1 with the FDD DL CC2.

Similarly, in order to increase communication bandwidth, the CSG 704 may aggregate the UL and/or DL of CC1 with CC2, but must protect the CC1 so as not to cause too much interference to the eNB 702 and the UE 706. The CSG 704 determines whether to aggregate the UL and/or DL of the CC1 with the CC2 for communication with the UE 708 based on an interference caused to the eNB 702 and the UE 706. If use on DL of the CC1 by the CSG 704 for communication with the UE 708 causes DL interference to the UE 706 that is less than a threshold, the CSG 704 may aggregate the DL of the CC1 for DL communication with the UE 708. If use on UL of the CC1 by the UE 708 causes UL interference 716′ to the eNB 702 that is less than a threshold, the CSG 704 may aggregate the UL of the CC1 for UL communication 716 with the UE 708. As shown in FIG. 7, the CSG 704 determined to aggregate the UL of the CC1 with the CC2 for communication with the UE 708, but not the DL of the CC1 with the CC2 for communication with the UE 708. If the CC2 and the CC1 are TDD, the CSG 704 aggregates the UL and the DL subframes of the TDD CC2 with the UL subframes of the TDD CC1. If the CC2 is TDD and the CC1 is FDD, the CSG 704 aggregates the UL and the DL subframes of the TDD CC2 with the FDD UL CC1. If the CC2 is FDD and the CC1 is TDD, the CSG 704 aggregates the FDD UL CC2 and the FDD DL CC2 with the UL subframes of the TDD CC1. If the CC2 and the CC1 are FDD, the CSG 704 aggregates the FDD UL CC2 and the FDD DL CC2 with the FDD UL CC1.

For some UEs, the eNB 702 may aggregate the full CC2 for bidirectional communication. Likewise, for some UEs the CSG 704 may aggregate the full CC1 for bidirectional communication. The eNB 702/CSG 704 determine whether to aggregate the full CC based on an interference level caused by such aggregation and communicate any aggregation to the UEs with which they communicate. The interference level may be determined based on a known or estimated location of the respective UEs or based on a communicated interference.

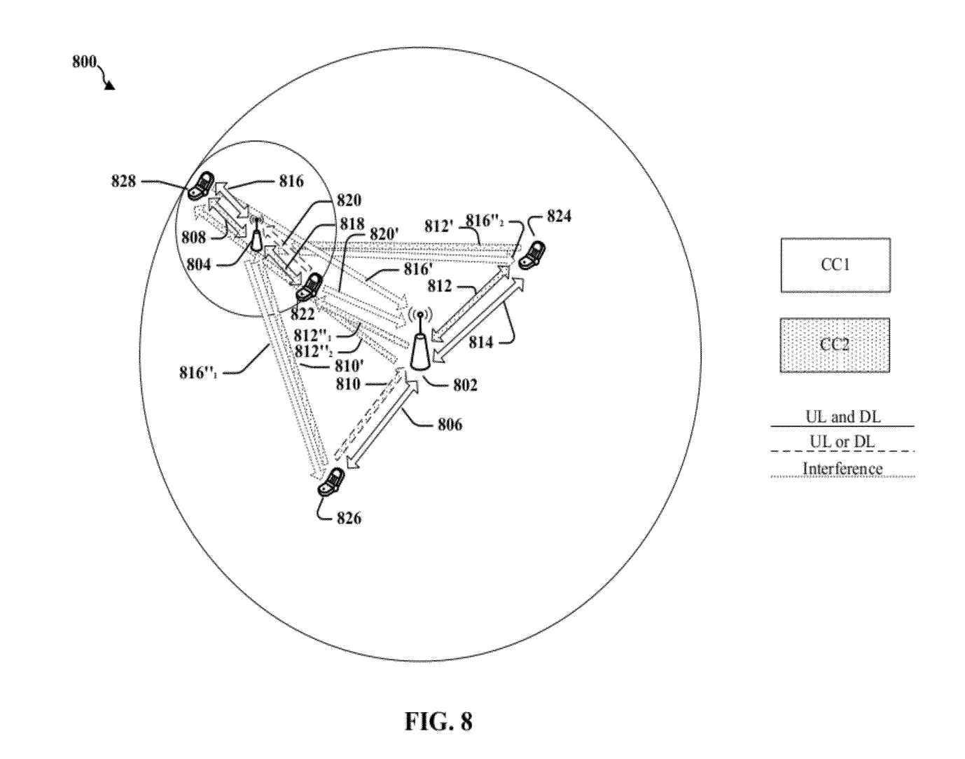

FIG. 8 is a second diagram 800 for illustrating a method for determining whether to aggregate carriers used by neighboring eNBs. As shown in FIG. 8, a CSG 804 is within the cell of the macro eNB 802. The CSG 804 may be a femto, nano, or pico cell, and may be referred to as an RRH. The eNB 802 communicates bidirectionally 806 with the UE 826 and bidirectionally 814 with the UE 824 through the anchor CC CC1. The CSG 804 communicates bidirectionally 808 with the UE 828 and bidirectionally 818 with the UE 822 through the anchor CC CC2. If the bidirectional communication is TDD, then the bidirectional communication is through one TDD CC, and if the bidirectional communication is FDD, then the bidirectional communication is through one FDD UL CC and one FDD DL CC.

In order to increase communication bandwidth with the UE 826, the eNB 802 may aggregate the UL and/or DL of CC2 with CC1, but must protect the CC2 so as not to cause too much interference to the CSG 804 and the UEs 822, 828. Further, any aggregation by the eNB 802 must protect the DL of the CSG 804, which operates at low power, to enable range expansion. The eNB 802 determines whether to aggregate the UL and/or DL of the CC2 with the CC1 for communication with the UE 826 based on an interference caused to the CSG 804 and the UEs 822, 828. If use on DL of the CC2 by the eNB 802 for communication with the UE 826 causes DL interference to the UEs 822, 828 that is less than a threshold, the eNB 802 may aggregate the DL of the CC2 for DL communication with the UE 826. If use on UL of the CC2 by the UE 826 causes UL interference 810′ to the CSG 804 that is less than a threshold, the eNB 802 may aggregate the UL of the CC2 for UL communication 810 with the UE 826. As shown in FIG. 8, the eNB 802 determined to aggregate the UL of the CC2 with the CC1 for communication with the UE 826, but not the DL of the CC2 with the CC1 for communication with the UE 826. If the CC1 and the CC2 are TDD, the eNB 802 aggregates the UL and the DL subframes of the TDD CC1 with the UL subframes of the TDD CC2. If the CC1 is TDD and the CC2 is FDD, the eNB 802 aggregates the UL and the DL subframes of the TDD CC1 with the FDD UL CC2. If the CC1 is FDD and the CC2 is TDD, the eNB 802 aggregates the FDD UL CC1 and the FDD DL CC1 with the UL subframes of the TDD CC2. If the CC1 and the CC2 are FDD, the eNB 802 aggregates the FDD UL CC1 and the FDD DL CC1 with the FDD UL CC2.

In order to increase communication bandwidth with the UE 824, the eNB 802 may aggregate the UL and/or DL of CC2 with CC1, but must protect the CC2 so as not to cause too much interference to the CSG 804 and the UEs 822, 828. The eNB 802 determines whether to aggregate the UL and/or DL of the CC2 with the CC1 for communication with the UE 824 based on an interference caused to the CSG 804 and the UEs 822, 828. If use on DL of the CC2 by the eNB 802 for communication with the UE 824 causes DL interference 812″₁, 812″₂ to the UEs 822, 828, respectively, that is less than a threshold, the eNB 802 may aggregate the DL of the CC2 for DL communication 812 with the UE 824. If use on UL of the CC2 by the UE 824 causes UL interference 812′ to the CSG 804 that is less than a threshold, the eNB 802 may aggregate the UL of the CC2 for UL communication 812 with the UE 824. As shown in FIG. 8, the eNB 802 determined to aggregate both the UL and the DL of the CC2 with the CC1 for communication with the UE 824. If the CC1 and the CC2 are TDD, the eNB 802 aggregates the UL and the DL subframes of the TDD CC1 with the UL and the DL subframes of the TDD CC2. If the CC1 is TDD and the CC2 is FDD, the eNB 802 aggregates the UL and the DL subframes of the TDD CC1 with the FDD UL CC2 and the FDD DL CC2. If the CC1 is FDD and the CC2 is TDD, the eNB 802 aggregates the FDD UL CC1 and the FDD DL CC1 with the UL and the DL subframes of the TDD CC2. If the CC1 and the CC2 are FDD, the eNB 802 aggregates the FDD UL CC1 and the FDD DL CC1 with the FDD UL CC2 and the FDD DL CC2.

Similarly, in order to increase communication bandwidth with the UE 822, the CSG 804 may aggregate the UL and/or DL of CC1 with CC2, but must protect the CC1 so as not to cause too much interference to the eNB 802 and the UEs 826, 824. The CSG 804 determines whether to aggregate the UL and/or DL of the CC1 with the CC2 for communication with the UE 822 based on an interference caused to the eNB 802 and the UEs 826, 824. If use on DL of the CC1 by the CSG 804 for communication with the UE 822 causes DL interference 816″₁, 816″₂ to the UEs 826, 824, respectively, that is less than a threshold, the CSG 804 may aggregate the DL of the CC1 for DL communication with the UE 822. If use on UL of the CC1 by the UE 822 causes UL interference 820′ to the eNB 802 that is less than a threshold, the CSG 804 may aggregate the UL of the CC1 for UL communication 820 with the UE 822. As shown in FIG. 8, the CSG 804 determined to aggregate the UL of the CC1 with the CC2 for communication with the UE 822, but not the DL of the CC1 with the CC2 for communication with the UE 822. If the CC2 and the CC1 are TDD, the CSG 804 aggregates the UL and the DL subframes of the TDD CC2 with the UL subframes of the TDD CC1. If the CC2 is TDD and the CC1 is FDD, the CSG 804 aggregates the UL and the DL subframes of the TDD CC2 with the FDD UL CC2. If the CC2 is FDD and the CC1 is TDD, the CSG 804 aggregates the FDD UL CC2 and the FDD DL CC2 with the UL subframes of the TDD CC1. If the CC2 and the CC1 are FDD, the CSG 804 aggregates the FDD UL CC2 and the FDD DL CC2 with the FDD UL CC1.

In order to increase communication bandwidth with the UE 828, the CSG 804 may aggregate the UL and/or DL of CC1 with CC2, but must protect the CC1 so as not to cause too much interference to the eNB 802 and the UEs 826, 824. The CSG 804 determines whether to aggregate the UL and/or DL of the CC1 with the CC2 for communication with the UE 828 based on an interference caused to the eNB 802 and the UEs 826, 824. If use on DL of the CC1 by the CSG 804 for communication with the UE 828 causes DL interference 816″₁, 816″₂ to the UEs 826, 824, respectively, that is less than a threshold, the CSG 804 may aggregate the DL of the CC1 for DL communication 816 with the UE 828. If use on UL of the CC1 by the UE 828 causes UL interference 816′ to the eNB 802 that is less than a threshold, the CSG 804 may aggregate the UL of the CC1 for UL communication 816 with the UE 828. As shown in FIG. 8, the CSG 804 determined to aggregate both the UL and the DL of the CC1 with the CC2 for communication with the UE 828. If the CC2 and the CC1 are TDD, the CSG 804 aggregates the UL and the DL subframes of the TDD CC2 with the UL and the DL subframes of the TDD CC1. If the CC2 is TDD and the CC1 is FDD, the CSG 804 aggregates the UL and the DL subframes of the TDD CC2 with the FDD UL CC1 and the FDD DL CC1. If the CC2 is FDD and the CC1 is TDD, the CSG 804 aggregates the FDD UL CC2 and the FDD DL CC2 with the UL and the DL subframes of the TDD CC1. If the CC2 and the CC1 are FDD, the CSG 804 aggregates the FDD UL CC2 and the FDD DL CC2 with the FDD UL CC1 and the FDD DL CC1.

For some UEs, the eNB 802 may aggregate the full CC2 for bidirectional communication. Likewise, for some UEs the CSG 804 may aggregate the full CC1 for bidirectional communication. The eNB 802/CSG 804 determine whether to aggregate the full CC based on an interference level caused by such aggregation and communicate any aggregation to the UEs with which they communicate. The interference level may be determined based on a known or estimated location of the respective UEs or based on a communicated interference. For example, if the UEs 822, 828 are close to the CSG 804 and the UE 824 is far from the CSG 804, the eNB 802 may aggregate both the UL and the DL of CC2 with CC1 for communication 812 with the UE 824, as the DL interference 812″₁, 812″₂ to the UEs 822, 828, respectively, may be less than a threshold and the UL interference 812′ to the CSG 804 may be less than a threshold. For another example, if the UEs 826, 824 are far from the CSG 804 and the UE 828 is far from the eNB 802, the CSG 804 may aggregate both the UL and the DL of CC1 with CC2 for communication 816 with the UE 828, as the DL interference 816″₁, 816″₂ to the UEs 826, 824, respectively, may be less than a threshold and the UL interference 816′ to the eNB 802 may be less than a threshold.

The thresholds may be set based on various factors. The threshold for determining whether the eNB 702/802 aggregates CC2 DL with the UL and the DL of CC1 may be based on protecting the DL of the CSG 704/804 to enable range expansion for the CSG 704/804. The threshold for determining whether the eNB 702/802 aggregates CC2 UL with the UL and the DL of CC1 may be based on protecting the UL of the CSG 704/804, especially if the UE with which the eNB 702/802 is communicating is in the coverage of the CSG 704/804. The threshold for determining whether the CSG 704/804 aggregates CC1 DL with the UL and the DL of CC2 may be based on protecting the DL of the eNB 702/802, especially if a UE with which the eNB 702/802 is communicating is in the coverage of the CSG 704/804. Lastly, the threshold for determining whether the CSG 704/804 aggregates CC1 UL with the UL and the DL of CC2 may be based on protecting the UL of the eNB 702/802.

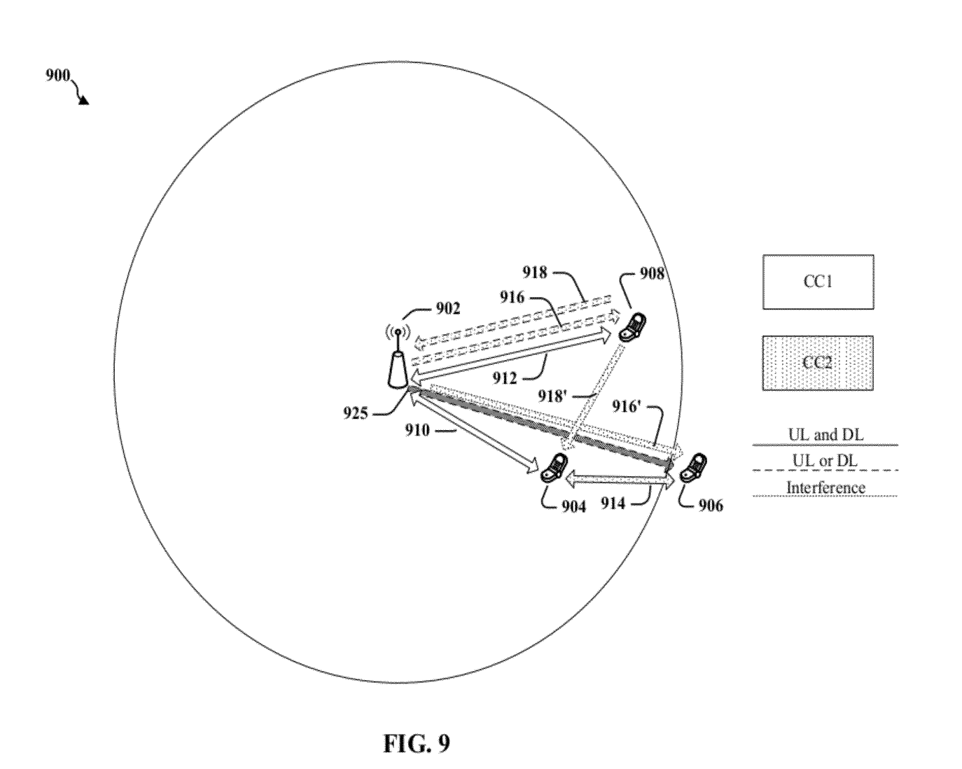

FIG. 9 is a diagram 900 for illustrating a method for determining whether to aggregate carriers within a relay setting. As shown in FIG. 9, the eNB 902 is communicating 910 with the UE 904 through the anchor CC CC1 and is communicating 912 with the UE 908 through the anchor CC CC1. The UE 904 is acting as a relay between the eNB 902 and the UE 906, which is just outside the coverage of the eNB 902. As such, the UE 904 receives DL communication from the eNB 902 in DL 910 through CC1 and relays the DL communication to the UE 906. The UE 904 relays the DL communication 914 to the UE 906 in DL resources of the CC CC2. The UE 904 receives UL communication 914 from the UE 906 in UL resources of the CC2, and relays the UL communication to the eNB 902 in UL 910 through the CC1. The eNB 902 determines whether to aggregate the UL 918 of the CC2 with the CC1 for communication with the UE 908 based on an UL interference 918′ caused to the UE 904. The eNB 902 determines whether to aggregate the DL 916 of the CC2 with the CC1 for communication with the UE 908 based on a DL interference 916′ caused to the UE 906. If use on UL 918 of the CC2 by the eNB 902 causes UL interference 918′ to the UE 904 that is less than a threshold, the eNB 902 may aggregate the UL 918 of the CC2 for UL communication 918 with the UE 908. If use on DL 916 of the CC2 by the eNB 902 causes DL interference 916′ to the UE 906 that is less than a threshold, the eNB 902 may aggregate the DL 916 of the CC2 for DL communication 916 with the UE 908.

The thresholds may be set based on various factors. The threshold for determining whether the eNB 902 aggregates CC2 DL 916 with the UL/DL 912 of CC1 may be based on a relative distance between the UEs 904, 906. Further, the threshold for determining whether the eNB 902 aggregates CC2 UL 918 with the UL/DL 912 of CC1 may be based on a relative distance between the UEs 904, 906. For example, the thresholds may be higher if the UEs 904, 906 are relatively close, as the DL interference 916′ and the UL interference 918′ are less likely to interfere with the communication between the UEs 904, 906.

With respect to the aggregation of carriers by the eNB 902, if the CC1 and the CC2 are TDD, the eNB 902 aggregates the UL and the DL subframes of the TDD CC1 with the UL and/or the DL subframes of the TDD CC2. If the CC1 is TDD and the CC2 is FDD, the eNB 902 aggregates the UL and the DL subframes of the TDD CC1 with the FDD UL CC2 and/or the FDD DL CC2. If the CC1 is FDD and the CC2 is TDD, the eNB 902 aggregates the FDD UL CC1 and the FDD DL CC1 with the UL and/or the DL subframes of the TDD CC2. If the CC1 and the CC2 are FDD, the eNB 902 aggregates the FDD UL CC1 and the FDD DL CC1 with the FDD UL CC2 and/or the FDD DL CC2.

In some designs, the eNB 902 may activate the UE 904 to act as a relay for the communication with UE 906. In some designs, relay activation may be based on the proximity detection between the UEs 904, 906. In some designs, proximity detection may be performed among UEs by peer-to-peer (P2P) communication and/or with assistance from the eNB 902. In some designs, relay activation may be prompted as a result of the P2P communication among the UEs. As such, the activation of the UE 904 to act as a relay for communication with the UE 906 may be based on at least one of a proximity detection between the UEs 904, 906; an existing peer-to-peer communication between the UEs 904, 906; or channel conditions of at least one of the UE 904 or the UE 906.

For the relay operation, TDD spectrum may be used for communication between two UEs performing range extension (e.g., UEs 904, 906 in FIG. 9). In other words, a TDD carrier may be used for communication between the two UEs 904, 906. In such a case, the communication between the relaying UE 904 and the serving eNB 902 may use FDD-TDD spectrum with carrier aggregation.

For the above-described configuration of FIG. 9, in some designs, only DL subframes of the TDD carrier may be used for carrier aggregation with FDD carriers. This aggregation strategy may provide interference protection of UL communication between the UE 906 and the UE 904. It may be noticed that if the UE-UE communication is established between relatively close UEs 904, 906, and the UE 906 is sufficiently far from the eNB 904, then interference protection of DL subframes of the TDD carrier may not be critical and may be optionally omitted. It will be appreciated that, as discussed previously, aggregated carriers on the DL may provide wider bandwidth for regular eNB-UE communication.

It will be appreciated that relay operation may be achieved by using most of the LTE Rel-10 PHY/MAC layer. Carrier aggregation may be performed on the eNB-UE link 902/908. The carrier aggregation may include combined TDD-FDD aggregation. Furthermore, the UE 904 may perform eNB functionality for the UE 906. Therefore, on the UE-UE link in the relay operation (e.g., between UE 904 and UE 906), regular Rel-10 TDD operation may be performed. To support the relaying functionality, the relaying UE (e.g., UE 904) may include additional modules to support the relay functionality including but not limited to, operation as an eNB and/or the ability to perform carrier aggregation.

It will be appreciated that the above-discussed relay operations techniques may be used to enhance the utilization of the TDD and FDD spectrum in a wireless communication system. In one aspect, wider bandwidth may be made available for eNB-UE communication by performing carrier aggregation. In another aspect, UE-UE communication may be performed to extend the reach of an eNB, and the UE-UE communication may be protected from potential interference by carrier aggregation. In one aspect, increased coverage for UEs farther away from the eNB may be provided. In another aspect, wireless UE-UE traffic may be offloaded, thereby opening up bandwidth. It will be appreciated that the disclosed relay operations may be backward compatible with single carrier FDD and TDD operations.

It will be appreciated that several aggregation techniques are disclosed, allowing combined FDD-TDD, FDD-FDD, TDD-FDD, and TDD-TDD aggregation. Furthermore, aggregation may be performed only in one direction—i.e., the UL or the DL, to avoid interference with anchor carriers of neighboring cells. It will also be appreciated that the disclosed aggregation techniques may facilitate a relay operation in which a UE is configured to operate as an eNB for another UE, thereby extending the range of a UE.

Referring again to FIG. 9, when the UE 906 is within range of the eNB 902, the eNB 902 may configure the UE 906 with a CC for receiving 925 control information from the eNB 902. The UE 906 aggregates the CC with CC2. The CC may be CC1 or a different CC, such as a CC3. In such a configuration, the eNB 902 may communicate data to the UE 904 for relaying to the UE 906. As such, the eNB 902 communicates control information directly to the UE 906 (through path 925) and communicates data to the UE 906 through the UE 904 (through path 910).

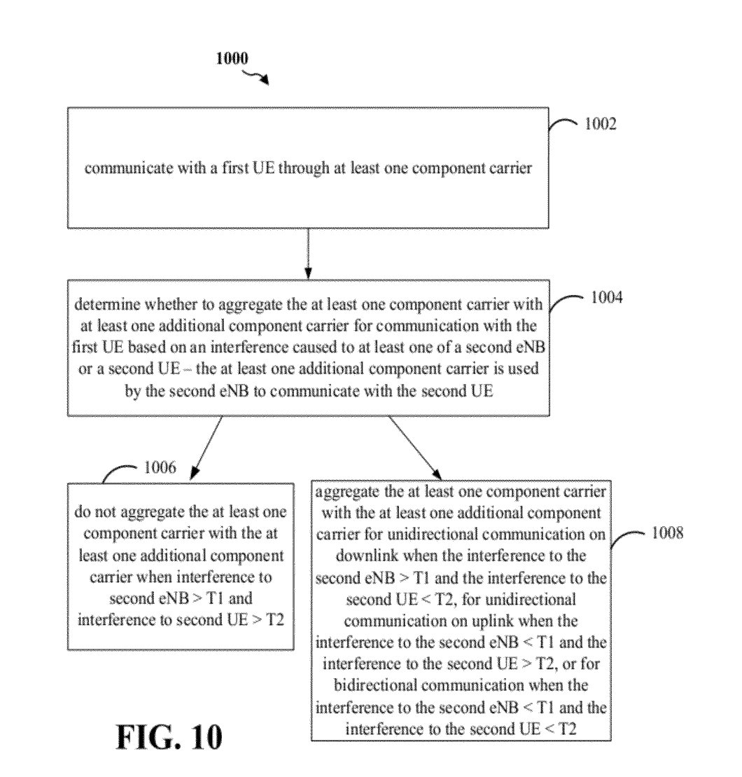

FIG. 10 is a flow chart 1000 of a method of wireless communication of an eNB. As shown in FIG. 10, in a first step 1002, the eNB communicates with a first UE through at least one CC. For example, the eNB 702 communicates 710 with the UE 706 through the CC1. In a second step 1004, the eNB determines whether to aggregate the at least one CC with at least one additional CC for communication with the first UE based on an interference caused to at least one of a second eNB or a second UE. The at least one additional CC is used by the second eNB to communicate with the second UE. For example, the eNB 702 determined to aggregate the CC2 DL with the CC1 for communication 710, 714 with the UE 706 based on an interference 714′ caused to the UE 708.

In one configuration, the at least one CC includes an FDD UL carrier and an FDD DL carrier, and the at least one additional CC includes at least one FDD carrier. In a first configuration, the eNB may aggregate the at least one CC with the at least one additional CC by aggregating the FDD UL carrier and a second FDD UL carrier for communication on an UL. The at least one FDD carrier includes the second FDD UL carrier. In addition, the eNB may aggregate the FDD DL carrier with the aggregated FDD UL carrier and the second FDD UL carrier. In a second configuration, the eNB may aggregate the at least one CC with the at least one additional CC by aggregating the FDD DL carrier and a second FDD DL carrier for communication on a DL. The at least one FDD carrier includes the second FDD DL carrier. In addition, the eNB may aggregate the FDD UL carrier with the aggregated FDD DL carrier and the second FDD DL carrier. For example, in relation to FIG. 7, if CC1 and CC2 are both FDD and CC1 includes a CC1 FDD UL carrier and a CC1 FDD DL carrier, the eNB 702 may aggregate the CC1 FDD DL carrier with the CC2 FDD DL carrier for the communication 710, 714 with the UE 706. In addition, the eNB 702 may aggregate the CC1 FDD UL carrier with the aggregated CC1 FDD DL carrier and the CC2 FDD DL carrier. As such, the eNB 702 and the UE 706 may communicate bidirectionally 710 through CC1 and communicate unidirectionally 714 through the CC2. Further, because the carriers are aggregated together, an UL transmission on the CC1 FDD UL carrier (path 710 on UL) may correspond to information (e.g., scheduling information) received on DL either through the CC1 FDD DL carrier (path 710 on DL) or the CC2 FDD DL carrier (path 714). Further, a DL transmission on the CC1 FDD DL carrier (path 710 on DL) or the CC2 FDD DL carrier (path 714) may correspond to an UL transmission on the CC1 FDD UL carrier (path 710 on UL).

In one configuration, the at least one CC includes an FDD UL carrier and an FDD DL carrier, and the at least one additional CC includes a TDD carrier. In a first configuration, the eNB may aggregate the at least one CC with the at least one additional CC by aggregating the FDD UL carrier and UL subframes of the TDD carrier for communication on an UL. In addition, the eNB may aggregate the FDD DL carrier with the aggregated FDD UL carrier and the UL subframes of the TDD carrier. In a second configuration, the eNB may aggregate the at least one CC with the at least one additional CC by aggregating the FDD DL carrier and DL subframes of the TDD carrier for communication on a DL. In addition, the eNB may aggregate the FDD UL carrier with the aggregated FDD DL carrier and the DL subframes of the TDD carrier. For example, in relation to FIG. 7, if CC1 is FDD, CC2 is FDD, and CC1 includes a CC1 FDD UL carrier and a CC1 FDD DL carrier, the eNB 702 may aggregate the CC1 FDD DL carrier with DL subframes of the CC2 TDD carrier for the communication 710, 714 with the UE 706. In addition, the eNB 702 may aggregate the CC1 FDD UL carrier with the aggregated CC1 FDD DL carrier and DL subframes of the CC2 TDD carrier. As such, the eNB 702 and the UE 706 may communicate bidirectionally 710 through CC1 and communicate unidirectionally 714 through the CC2. Further, because the carriers are aggregated together, an UL transmission on the CC1 FDD UL carrier (path 710 on UL) may correspond to information (e.g., scheduling information) received on DL either through the CC1 FDD DL carrier (path 710 on DL) or the DL subframes of the CC2 TDD carrier (path 714). Further, a DL transmission on the CC1 FDD DL carrier (path 710 on DL) or the DL subframes of the CC2 TDD carrier (path 714) may correspond to an UL transmission on the CC1 FDD UL carrier (path 710 on UL).

In one configuration, the at least one CC includes a TDD carrier including UL subframes and DL subframes and the at least one additional CC includes at least one FDD carrier. In a first configuration, the eNB may aggregate the at least one CC with the at least one additional CC by aggregating the UL subframes of the TDD carrier and an FDD UL carrier for communication on an UL. The at least one FDD carrier includes the FDD UL carrier. In addition, the eNB may aggregate the DL subframes and the UL sub frames of the TDD carrier with the FDD UL carrier. In a second configuration, the eNB may aggregate the at least one CC with the at least one additional CC by aggregating the DL subframes of the TDD carrier and an FDD DL carrier for communication on a DL. The at least one FDD carrier includes the FDD DL carrier. In addition, the eNB may aggregate the UL subframes and the DL subframes of the TDD carrier with the FDD DL carrier. For example, in relation to FIG. 7, if CC1 is TDD and CC2 is FDD, the eNB 702 may aggregate the DL subframes of the CC1 TDD carrier with the CC2 FDD DL carrier for the communication 710, 714 with the UE 706. In addition, the eNB 702 may aggregate the UL subframes of the CC1 TDD carrier with the aggregated DL subframes of the CC1 TDD carrier and the CC2 FDD DL carrier. As such, the eNB 702 and the UE 706 may communicate bidirectionally 710 through CC1 and communicate unidirectionally 714 through the CC2. Further, because the carriers are aggregated together, an UL transmission on the UL subframes of the CC1 TDD carrier (path 710 on UL) may correspond to information (e.g., scheduling information) received on DL either through the DL subframes of the CC1 TDD carrier (path 710 on DL) or the CC2 FDD DL carrier (path 714). Further, a DL transmission on the DL subframes of the CC1 TDD carrier (path 710 on DL) or the CC2 FDD DL carrier (path 714) may correspond to an UL transmission on the UL subframes of the CC1 TDD carrier (path 710 on UL).

In one configuration, the at least one CC includes a first TDD carrier including first TDD UL subframes and first TDD DL subframes and the at least one additional CC includes a second TDD carrier including second TDD UL subframes and second TDD DL subframes. In a first configuration, the eNB may aggregate the at least one CC with the at least one additional CC by aggregating the first TDD UL subframes and the second TDD UL subframes for communication on an UL. In addition, the eNB may aggregate the first TDD UL subframes and the first TDD DL subframes with the second TDD UL subframes. In a second configuration, the eNB may aggregate the at least one CC with the at least one additional CC by aggregating the first TDD DL subframes and the second TDD DL subframes for communication on a DL. In addition, the eNB may aggregate the first TDD UL subframes and the first TDD DL subframes with the second TDD DL subframes. For example, in relation to FIG. 7, if CC1 and CC2 are both TDD, the eNB 702 may aggregate the DL subframes of the CC1 TDD carrier with the DL subframes of the CC2 TDD carrier for the communication 710, 714 with the UE 706. In addition, the eNB 702 may aggregate the UL subframes of the CC1 TDD carrier with the aggregated DL subframes of the CC1 TDD carrier and the DL subframes of the CC2 TDD carrier. As such, the eNB 702 and the UE 706 may communicate bidirectionally 710 through CC1 and communicate unidirectionally 714 through the CC2. Further, because the carriers are aggregated together, an UL transmission on the UL subframes of the CC1 TDD carrier (path 710 on UL) may correspond to information (e.g., scheduling information) received on DL either through the DL subframes of the CC1 TDD carrier (path 710 on DL) or the DL subframes of the CC2 TDD carrier (path 714). Further, a DL transmission on the DL subframes of the CC1 TDD carrier (path 710 on DL) or the DL subframes of the CC2 TDD carrier (path 714) may correspond to an UL transmission on the UL subframes of the CC1 TDD carrier (path 710 on UL). In one configuration, when CC1 and CC2 are both TDD, the first TDD carrier and the second TDD carrier have different subframe UL and DL configurations. That is, which subframes within a frame are for DL and UL may differ between the CC1 TDD carrier and the CC2 TDD carrier.

Referring again to FIG. 10, in step 1006, the eNB may determine not to aggregate the at least one CC and the at least one additional CC for communication with the first UE when communication by the first UE on an UL through the at least one additional CC causes interference to the second eNB that is greater than a first interference threshold T₁ or communication by the first eNB on a DL through the at least one additional CC causes interference to the second UE that is greater than a second interference threshold T₂.

In one configuration, the eNB may determine whether to communicate unidirectionally or bidirectionally with the first UE through the at least one additional CC. In step 1008, the eNB may aggregate the at least one CC and the at least one additional CC for unidirectional communication with the first UE on an UL when the communication by the first UE on the UL through the at least one additional CC causes interference to the second eNB that is less than a first interference threshold T₁ and communication by the first eNB on a DL through the at least one additional CC causes interference to the second UE that is greater than a second interference threshold T₂. Further, in step 1008, the eNB may aggregate the at least one CC and the at least one additional CC for unidirectional communication with the first UE on a DL when the communication by the first UE on an UL through the at least one additional CC causes interference to the second eNB that is greater than a first interference threshold T₁ and the communication by the first eNB on the DL through the at least one additional CC causes interference to the second UE that is less than a second interference threshold T₂. Further, in step 1008, the eNB may aggregate the at least one CC and the at least one additional CC for bidirectional communication with the first UE on an UL and a DL when the communication by the first UE on the UL through the at least one additional CC causes interference to the second eNB that is less than a first interference threshold T₁ and the communication by the first eNB on the DL through the at least one additional CC causes interference to the second UE that is less than a second interference threshold T₂.

For example, with respect to FIG. 7, the eNB 702 determined that interference from the UE 706 to the CSG 704 (due to aggregation of the CC2 UL for communication with the UE 706) was greater than a threshold T₁, but that interference 714′ from the eNB 702 to the UE 708 (due to aggregation of the CC2 DL for communication with the UE 706) was less than a threshold T₂. As such, the eNB 702 aggregated the CC1 DL and the CC2 DL for unidirectional communication on DL with the UE 706. For another example, with respect to FIG. 8, the CSG 804 determined that interference 816″₁ from the CSG 804 to the UE 826 (due to aggregation of the CC1 DL for communication with the UE 822) and interference 816″₂ from the CSG 804 to the UE 824 (due to aggregation of the CC1 DL for communication with the UE 822) were greater than a threshold T₂, but that interference 820′ from the UE 822 to the eNB 802 (due to aggregation of the CC1 UL for communication with the UE 822) was less than a threshold T₁. As such, the CSG 804 aggregated the CC2 UL and the CC1 UL for unidirectional communication on UL with the UE 822.

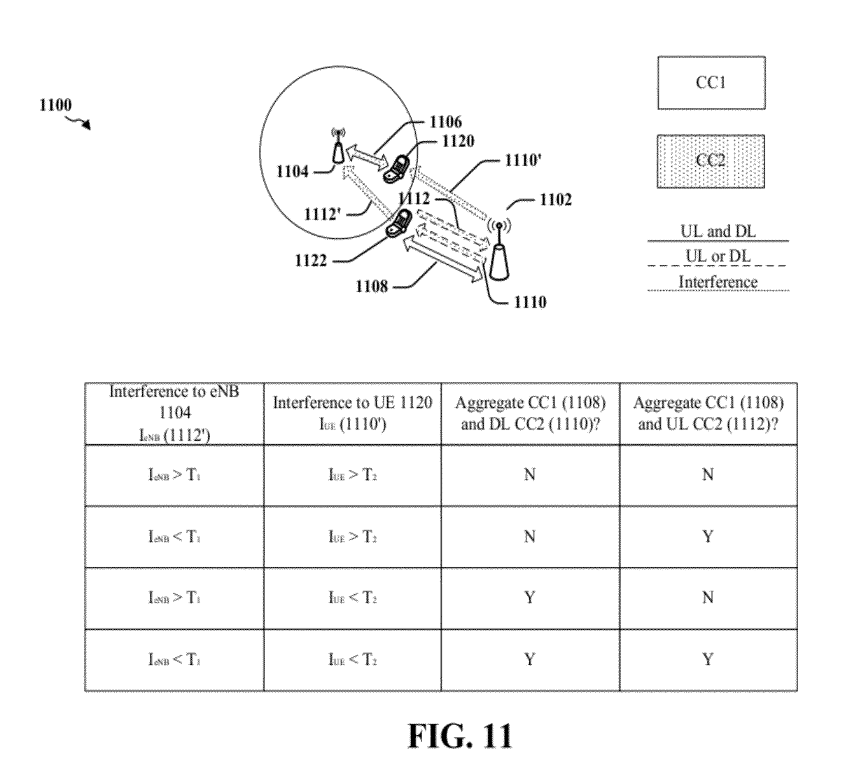

FIG. 11 is a diagram and table 1100 for illustrating when carriers are aggregated by the eNB 1102 for communication with the UE 1122 with respect to an interference caused by the eNB 1102 and the UE 1122. As shown in the diagram, the CSG 1104 is communicating 1106 through CC2 with the UE 1120 and the eNB 1102 is communicating 1108 through CC1 with the UE 1122. The eNB 1102 determines whether to aggregate CC1 and CC2 for UL communication 1108, 1112 based on whether the interference I_{eNB} 1112′ from the UE 1122 to the CSG 1104 is less than a threshold T₁, and determines whether to aggregate CC1 and CC2 for DL communication 1108, 1110 based on whether the interference I_{UE} 1110′ from the eNB 1102 to the UE 1120 is less than a threshold T₂. As shown in the table, when I_{eNB}>T₁ and I_{UE}>T₂, the eNB 1102 does not aggregate CC1 (1108) and DL CC2 (1110) and does not aggregate CC1 (1108) and UL CC2 (1112); when I_{eNB}<T₁ and I_{UE}>T₂, the eNB 1102 does not aggregate CC1 (1108) and DL CC2 (1110) and aggregates CC1 (1108) and UL CC2 (1112); when I_{eNB}>T₁ and I_{UE}<T₂, the eNB 1102 aggregates CC1 (1108) and DL CC2 (1110) and does not aggregate CC1 (1108) and UL CC2 (1112); and when I_{eNB}<T₁ and I_{UE}<T₂, the eNB 1102 aggregates CC1 (1108) and DL CC2 (1110) and aggregates CC1 (1108) and UL CC2 (1112).

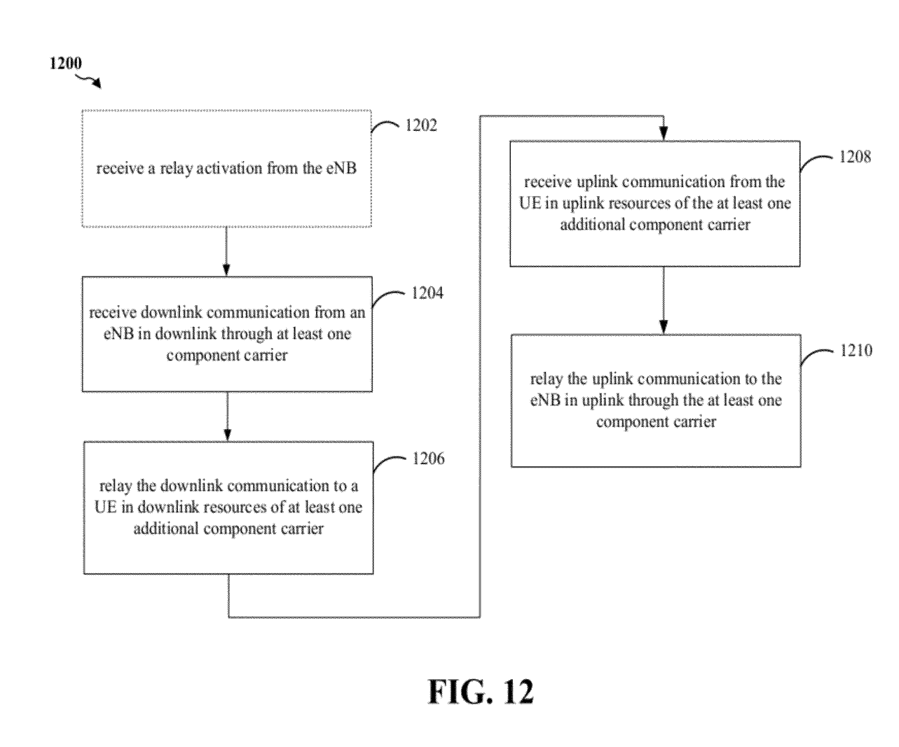

FIG. 12 is a flow chart 1200 of a method of wireless communication of a UE within a relay setting. As shown in FIG. 12, in step 1202, the UE may receive a relay activation from the eNB. In step 1204, the UE receives DL communication from an eNB in DL through at least one CC. In step 1206, the UE relays the DL communication to a second UE in DL resources of at least one additional CC. In step 1208, the UE receives UL communication from the second UE in UL resources of the at least one additional CC. In step 1210, the UE relays the UL communication to the eNB in UL through the at least one CC.

In one configuration, the at least one CC includes an FDD UL carrier and an FDD DL carrier, and the at least one additional CC includes a TDD carrier including UL and DL subframes; the at least one CC includes a first FDD UL carrier and a first FDD DL carrier, and the at least one additional CC includes a second FDD UL carrier and a second FDD DL carrier; the at least one CC includes a TDD carrier including UL and DL subframes, and the at least one additional CC includes an FDD UL carrier and an FDD DL carrier; or the at least one CC includes a first TDD carrier including UL and DL subframes, and the at least one additional CC includes a second TDD carrier including UL and DL subframes.

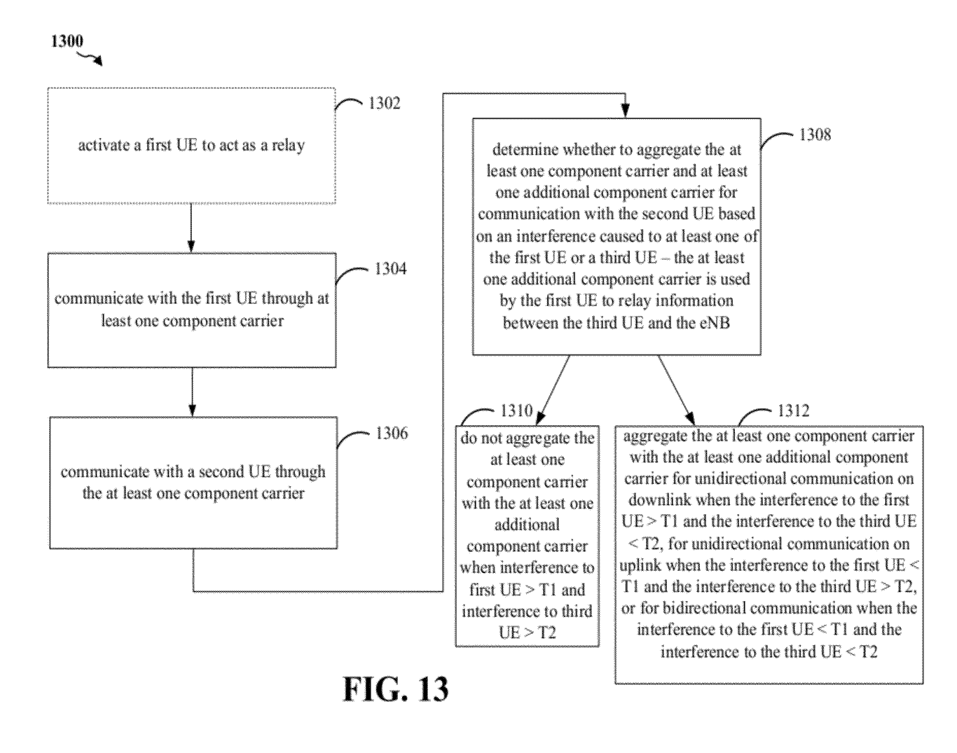

FIG. 13 is a flow chart 1300 of a method of wireless communication of an eNB within a relay setting. In step 1302, the eNB may activate a first UE to act as a relay. In step 1304, the eNB communicates with the first UE through at least one CC. In step 1306, the eNB communicates with a second UE through the at least one CC. In step 1308, the eNB determines whether to aggregate the at least one CC and at least one additional CC for communication with the second UE based on an interference caused to at least one of the first UE or a third UE. The at least one additional CC is used by the first UE to relay information between the third UE and the eNB. For example, as shown in FIG. 9, the eNB 902 communicates with the UE 904 and the UE 908 through CC1. The eNB 902 determines whether to aggregate the CC1 and the CC2 for communication with the UE 908 based on an interference 918′ caused to the UE 904 and/or an interference 916′ caused to the UE 906. The CC2 is used by the UE 904 to relay information between the UE 906 and the eNB 902.

In one configuration, the at least one CC includes an FDD UL carrier and an FDD DL carrier, and the at least one additional CC includes at least one FDD carrier. In a first configuration, the eNB may aggregate the at least one CC with the at least one additional CC by aggregating the FDD UL carrier and a second FDD UL carrier for communication on an UL with the second UE, the at least one FDD carrier including the second FDD UL carrier. In addition, the eNB may aggregate the FDD DL carrier with the aggregated FDD UL carrier and the second FDD UL carrier. In a second configuration, the eNB may aggregate the at least one CC with the at least one additional CC by aggregating the FDD DL carrier and a second FDD DL carrier for communication on a DL with the second UE, the at least one FDD carrier including the second FDD DL carrier. In addition, the eNB may aggregate the FDD UL carrier with the aggregated FDD DL carrier and the second FDD DL carrier.

In one configuration, the at least one CC includes an FDD UL carrier and an FDD DL carrier, and the at least one additional CC includes a TDD carrier including UL subframes and DL subframes. In a first configuration, the eNB may aggregate the at least one CC with the at least one additional CC by aggregating the FDD UL carrier and the UL subframes of the TDD carrier for communication on an UL with the second UE. In addition, the eNB may aggregate the FDD DL carrier with the aggregated FDD UL carrier and the UL subframes of the TDD carrier. In a second configuration, the eNB may aggregate the at least one CC with the at least one additional CC by aggregating the FDD DL carrier and the DL subframes of the TDD carrier for communication on a DL with the second UE. In addition, the eNB may aggregate the FDD UL carrier with the aggregated FDD DL carrier and the DL subframes of the TDD carrier.

In one configuration, the at least one CC includes a TDD carrier including UL subframes and DL subframes and the at least one additional CC includes at least one FDD carrier. In a first configuration, the eNB may aggregate the at least one CC with the at least one additional CC by aggregating the UL subframes of the TDD carrier and an FDD UL carrier for communication on an UL with the second UE. The at least one FDD carrier is the FDD UL carrier. In addition, the eNB may aggregate the DL subframes and the UL subframes of the TDD carrier with the FDD UL carrier. In a second configuration, the eNB may aggregate the at least one CC with the at least one additional CC by aggregating the DL subframes of the TDD carrier and an FDD DL carrier for communication on a DL with the second UE. The at least one FDD carrier is the FDD DL carrier. In addition, the eNB may aggregate the UL subframes and the DL subframes of the TDD carrier with the FDD DL carrier.

In one configuration, the at least one CC includes a first TDD carrier including first TDD UL subframes and first TDD DL subframes, and the at least one additional CC includes a second TDD carrier including second TDD UL subframes and second TDD DL subframes. In a first configuration, the eNB may aggregate the at least one CC with the at least one additional CC by aggregating the first TDD UL subframes and the second TDD UL subframes for communication on an UL with the second UE. In addition, the eNB may aggregate the first TDD UL subframes and the first TDD DL subframes with the second TDD UL subframes. In a second configuration, the eNB may aggregate the at least one CC with the at least one additional CC by aggregating the first TDD DL subframes and the second TDD DL subframes for communication on a DL with the second UE. In addition, the eNB may aggregate the first TDD UL subframes and the first TDD DL subframes with the second TDD DL subframes. In one configuration, the first TDD carrier and the second TDD carrier have different subframe UL and DL configurations.

In step 1310, the eNB determines not to aggregate the at least one CC and the at least one additional CC for communication with the second UE when communication by the second UE on an UL through the at least one additional CC causes interference to the first UE that is greater than a first interference threshold T₁ and communication by the eNB on a DL through the at least one additional CC causes interference to the third UE that is greater than a second interference threshold T₂.

In one configuration, the eNB may determine whether to communicate unidirectionally or bidirectionally with the second UE through the at least one additional CC. In step 1312, the eNB aggregates the at least one CC and the at least one additional CC for unidirectional communication with the second UE on an UL when the communication by the second UE on the UL through the at least one additional CC causes interference to the first UE that is less than a first interference threshold T₁ and communication by the eNB on a DL through the at least one additional CC causes interference to the third UE that is greater than a second interference threshold T₂. Further, the eNB aggregates the at least one CC and the at least one additional CC for unidirectional communication with the second UE on a DL when the communication by the second UE on an UL through the at least one additional CC causes interference to the first UE that is greater than a first interference threshold T₁ and the communication by the eNB on the DL through the at least one additional CC causes interference to the third UE that is less than a second interference threshold T₂. Further, the eNB aggregates the at least one CC and the at least one additional CC for bidirectional communication with the second UE on an UL and a DL when the communication by the second UE on the UL through the at least one additional CC causes interference to the first UE that is less than a first interference threshold T₁ and the communication by the eNB on the DL through the at least one additional CC causes interference to the third UE that is less than a second interference threshold T₂.

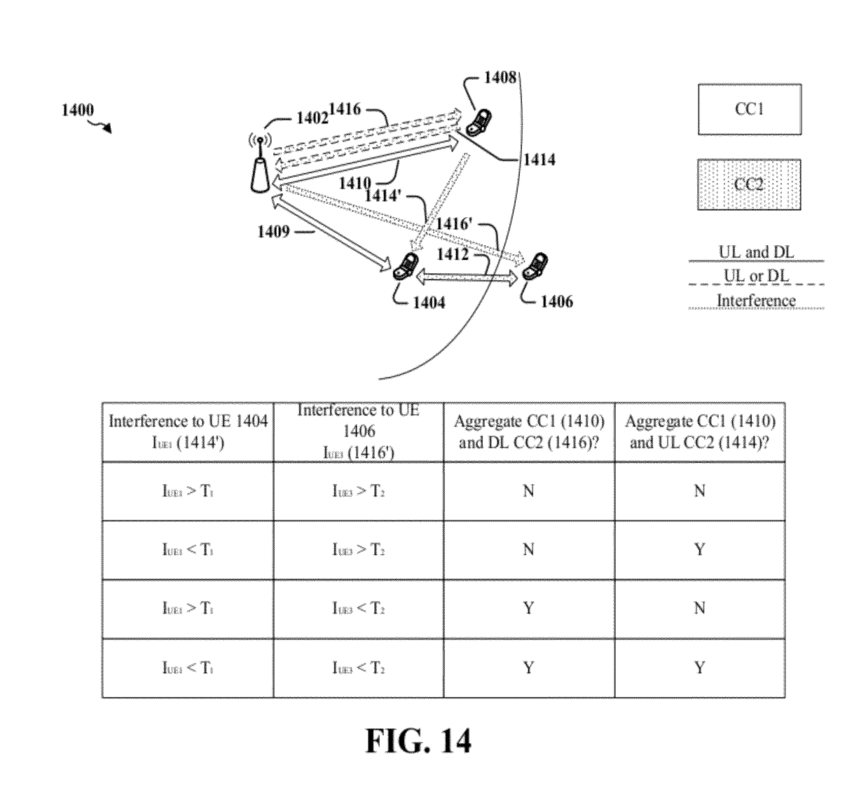

FIG. 14 is a diagram and table 1400 for illustrating when carriers are aggregated by the eNB 1402 for communication with the UE 1408 with respect to an interference in a relay setting caused by the eNB 1402 and the UE 1408. As shown in the diagram, the eNB 1402 is communicating 1409 through CC1 with the UE 1404 and is communicating 1410 through CC1 with the UE 1408. The UE 1404 is communicating 1412 through CC2 with the UE 1406, which is outside the range of the eNB 1402. The eNB 1402 determines whether to aggregate CC1 and CC2 for UL communication 1410, 1414 based on whether the interference I_{UE1} 1414′ from the UE 1408 to the UE 1404 is less than a threshold T₁, and determines whether to aggregate CC1 and CC2 for DL communication 1410, 1416 based on whether the interference I_{UE3} 1416′ from the eNB 1402 to the UE 1406 is less than a threshold T₂. As shown in the table, when I_{UE1}>T₁ and I_{UE3}>T₂, the eNB 1402 does not aggregate CC1 (1410) and DL CC2 (1416) and does not aggregate CC1 (1410) and UL CC2 (1414); when I_{UE1}<T₁ and I_{UE3}>T₂, the eNB 1402 does not aggregate CC1 (1410) and DL CC2 (1416) and aggregates CC1 (1410) and UL CC2 (1414); when I_{UE1}>T₁ and I_{UE3}<T₂, the eNB 1402 aggregates CC1 (1410) and DL CC2 (1416) and does not aggregate CC1 (1410) and UL CC2 (1414); and when I_{UE1}<T₁ and I_{UE3}<T₂, the eNB 1402 aggregates CC1 (1410) and DL CC2 (1416) and aggregates CC1 (1410) and UL CC2 (1414).

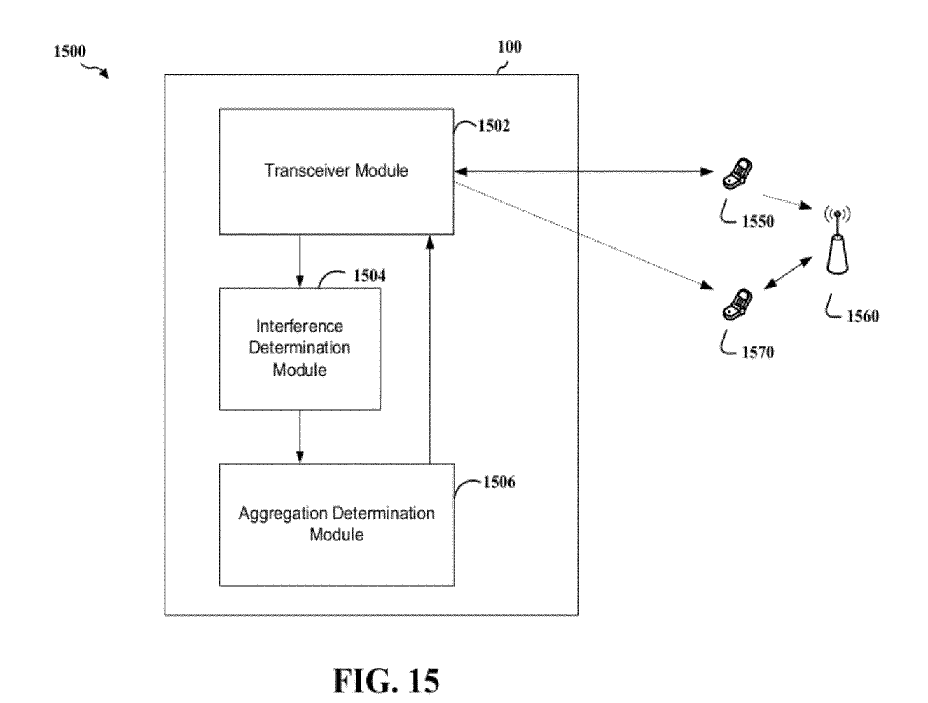

FIG. 15 is a conceptual data flow diagram 1500 illustrating the data flow between different modules/means/components in an exemplary first eNB apparatus 100. The apparatus 100 includes a transceiver module 1502 that communicates with a first UE 1550 through at least one CC. In addition, the apparatus 100 includes an interference determination module 1504 that determines an interference caused to a second eNB 1560 and/or a second UE 1570. Further, the apparatus 100 includes an aggregation determination module 1506 that receives the inference information from the interference determination module 1504 and determines whether to aggregate the at least one CC with at least one additional CC for communication with the first UE 1550 based on an interference caused to at least one of the second eNB 1560 or the second UE 1570. The at least one additional CC is used by the second eNB 1560 to communicate with the second UE 1570. The determination to aggregate CCs is provided to the transceiver module 1502, which configures itself to communicate with the first UE 1550 through the aggregated CCs.

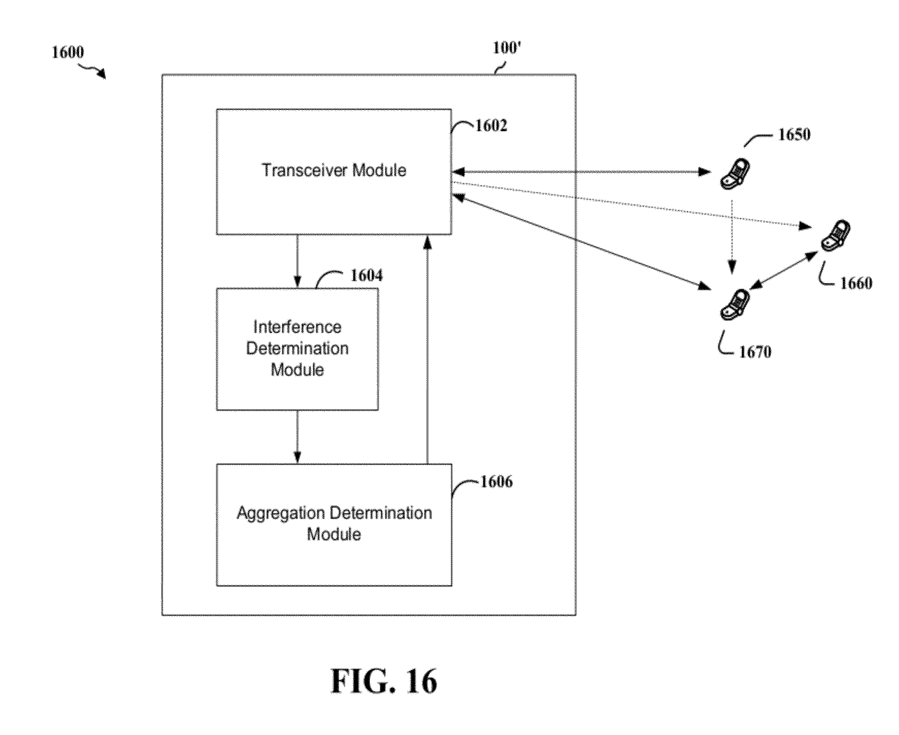

FIG. 16 is a conceptual data flow diagram 1600 illustrating the data flow between different modules/means/components in an exemplary eNB apparatus 100′. The apparatus 100′ includes a transceiver module 1602 that communicates with a first UE 1670 through at least one CC. The transceiver module 1602 also communicates with a second UE 1650 through the at least one CC. The apparatus 100′ further includes an interference determination module 1604 that determines an interference caused to the first UE 1670 and/or a third UE 1660, which is in peer-to-peer communication with the first UE 1670. The apparatus 100′ further includes an aggregation determination module 1606 that determines whether to aggregate the at least one CC and at least one additional CC for communication with the second UE 1650 based on the interference caused to the first UE 1670 and/or the third UE 1660. The at least one additional CC is used by the first UE 1670 to relay information between the third UE 1660 and the eNB 100′. The determination to aggregate CCs is provided to the transceiver module 1602, which configures itself to communicate with the first UE 1650 through the aggregated CCs.

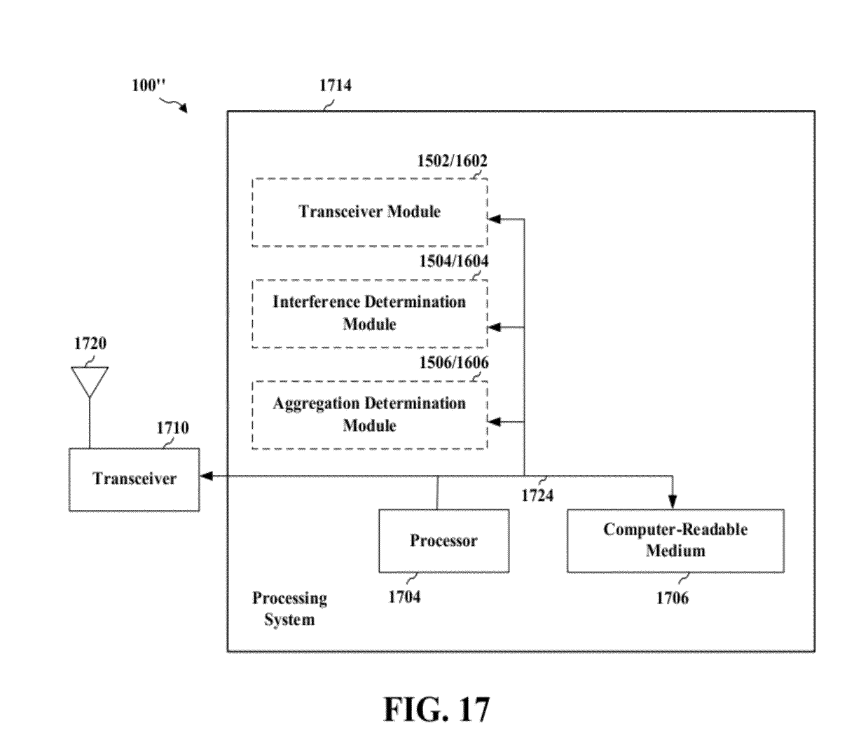

FIG. 17 is a diagram 1700 illustrating an example of a hardware implementation for an eNB apparatus 100″ employing a processing system 1714. The processing system 1714 may be implemented with a bus architecture, represented generally by the bus 1724. The bus 1724 may include any number of interconnecting buses and bridges depending on the specific application of the processing system 1714 and the overall design constraints. The bus 1724 links together various circuits including one or more processors and/or hardware modules, represented by the processor 1704, the modules 1502/1602, 1504/1604, 1506/1606 and the computer-readable medium 1706. The bus 1724 may also link various other circuits such as timing sources, peripherals, voltage regulators, and power management circuits, which are well known in the art, and therefore, will not be described any further. The apparatus includes a processing system 1714 coupled to a transceiver 1710. The transceiver 1710 is coupled to one or more antennas 1720. The transceiver 1710 provides a means for communicating with various other apparatus over a transmission medium. The processing system 1714 includes a processor 1704 coupled to a computer-readable medium 1706. The processor 1704 is responsible for general processing, including the execution of software stored on the computer-readable medium 1706. The software, when executed by the processor 1704, causes the processing system 1714 to perform the various functions described supra for any particular apparatus. The computer-readable medium 1706 may also be used for storing data that is manipulated by the processor 1704 when executing software. The processing system further includes modules 1502/1602, 1504/1604, 1506/1606. The modules may be software modules running in the processor 1704, resident/stored in the computer readable medium 1706, one or more hardware modules coupled to the processor 1704, or some combination thereof. The processing system 1714 may be a component of the eNB 110 and may include the memory 342 and/or at least one of the TX processor 320, the RX processor 338, and the controller/processor 340.

In one configuration, the apparatus 100/100″ for wireless communication includes means for communicating with a first UE through at least one CC. The apparatus further includes means for determining whether to aggregate the at least one CC with at least one additional CC for communication with the first UE based on an interference caused to at least one of a second eNB or a second UE. The at least one additional CC is used by the second eNB to communicate with the second UE. The apparatus may further include means for aggregating the at least one CC with the at least one additional CC by aggregating the FDD UL carrier and a second FDD UL carrier for communication on an UL. The at least one FDD carrier includes the second FDD UL carrier. The apparatus may further include means for aggregating the FDD DL carrier with the aggregated FDD UL carrier and the second FDD UL carrier. The apparatus may further include means for aggregating the at least one CC with the at least one additional CC by aggregating the FDD DL carrier and a second FDD DL carrier for communication on a DL. The at least one FDD carrier includes the second FDD DL carrier. The apparatus may further include means for aggregating the FDD UL carrier with the aggregated FDD DL carrier and the second FDD DL carrier. The apparatus may further include means for aggregating the at least one CC with the at least one additional CC by aggregating the FDD UL carrier and UL subframes of the TDD carrier for communication on an UL. The apparatus may further include means for aggregating the FDD DL carrier with the aggregated FDD UL carrier and the UL subframes of the TDD carrier. The apparatus may further include means for aggregating the at least one CC with the at least one additional CC by aggregating the FDD DL carrier and DL subframes of the TDD carrier for communication on a DL. The apparatus may further include means for aggregating the FDD UL carrier with the aggregated FDD DL carrier and the DL subframes of the TDD carrier. The apparatus may further include means for aggregating the at least one CC with the at least one additional CC by aggregating the UL subframes of the TDD carrier and an FDD UL carrier for communication on an UL. The at least one FDD carrier includes the FDD UL carrier. The apparatus may further include means for aggregating the DL subframes and the UL subframes of the TDD carrier with the FDD UL carrier. The apparatus may further include means for aggregating the at least one CC with the at least one additional CC by aggregating the DL subframes of the TDD carrier and an FDD DL carrier for communication on a DL. The at least one FDD carrier includes the FDD DL carrier. The apparatus may further include means for aggregating the UL subframes and the DL subframes of the TDD carrier with the FDD DL carrier. The apparatus may further include means for aggregating the at least one CC with the at least one additional CC by aggregating the first TDD UL subframes and the second TDD UL subframes for communication on an UL. The apparatus may further include means for aggregating the first TDD UL subframes and the first TDD DL subframes with the second TDD UL subframes. The apparatus may further include means for aggregating the at least one CC with the at least one additional CC by aggregating the first TDD DL subframes and the second TDD DL subframes for communication on a DL. The apparatus may further include means for aggregating the first TDD UL subframes and the first TDD DL subframes with the second TDD DL subframes. The apparatus may further include means for determining not to aggregate the at least on CC and the at least one additional CC for communication with the first UE when communication by the first UE on an UL through the at least one additional CC causes interference to the second eNB that is greater than a first interference threshold or communication by the first eNB on a DL through the at least one additional CC causes interference to the second UE that is greater than a second interference threshold. The apparatus may further include means for determining whether to communicate unidirectionally or bidirectionally with the first UE through the at least one additional CC. The apparatus may further include means for aggregating the at least one CC and the at least one additional CC for unidirectional communication with the first UE on an UL when the communication by the first UE on the UL through the at least one additional CC causes interference to the second eNB that is less than a first interference threshold and communication by the first eNB on a DL through the at least one additional CC causes interference to the second UE that is greater than a second interference threshold. The apparatus may further include means for aggregating the at least one CC and the at least one additional CC for unidirectional communication with the first UE on a DL when the communication by the first UE on an UL through the at least one additional CC causes interference to the second eNB that is greater than a first interference threshold and the communication by the first eNB on the DL through the at least one additional CC causes interference to the second UE that is less than a second interference threshold. The apparatus may further include means for aggregating the at least one CC and the at least one additional CC for bidirectional communication with the first UE on an UL and a DL when the communication by the first UE on the UL through the at least one additional CC causes interference to the second eNB that is less than a first interference threshold and the communication by the first eNB on the DL through the at least one additional CC causes interference to the second UE that is less than a second interference threshold. The apparatus may further include means for transmitting control information to the third UE through a CC. The CC may be one of the at least one CC or a different CC. The CC may be aggregated with the at least one additional CC by the third UE. The information relayed by the first UE to the third UE may be only data from the eNB. The aforementioned means may be one or more of the aforementioned modules 1502, 1504, 1506 of the apparatus 100/100″ and/or the processing system 1714 of the apparatus 100″ configured to perform the functions recited by the aforementioned means. As described supra, the processing system 1714 may include the memory 342 and/or at least one of the TX processor 320, the RX processor 338, and the controller/processor 340. As such, in one configuration, the aforementioned means may be the TX processor 320, the RX processor 338, and the controller/processor 340 configured to perform the functions recited by the aforementioned means.

In one configuration, the apparatus 100′/100″ for wireless communication includes means for communicating with a first UE through at least one CC, means for communicating with a second UE through the at least one CC, and means for determining whether to aggregate the at least one CC and at least one additional CC for communication with the second UE based on an interference caused to at least one of the first UE or a third UE. The at least one additional CC is used by the first UE to relay information between the third UE and the eNB. The apparatus may further include means for activating the first UE to act as a relay. The apparatus may further include means for aggregating the at least one CC with the at least one additional CC by aggregating the FDD UL carrier and a second FDD UL carrier for communication on an UL with the second UE. The at least one FDD carrier includes the second FDD UL carrier. The apparatus may further include means for aggregating the FDD DL carrier with the aggregated FDD UL carrier and the second FDD UL carrier. The apparatus may further include means for aggregating the at least one CC with the at least one additional CC by aggregating the FDD DL carrier and a second FDD DL carrier for communication on a DL with the second UE. The at least one FDD carrier includes the second FDD DL carrier. The apparatus may further include means for aggregating the FDD UL carrier with the aggregated FDD DL carrier and the second FDD DL carrier. The apparatus may further include means for aggregating the at least one CC with the at least one additional CC by aggregating the FDD UL carrier and the UL subframes of the TDD carrier for communication on an UL with the second UE. The apparatus may further include means for aggregating the FDD DL carrier with the aggregated FDD UL carrier and the UL subframes of the TDD carrier. The apparatus may further include means for aggregating the at least one CC with the at least one additional CC by aggregating the FDD DL carrier and the DL subframes of the TDD carrier for communication on a DL with the second UE. The apparatus may further include means for aggregating the FDD UL carrier with the aggregated FDD DL carrier and the DL subframes of the TDD carrier. The apparatus may further include means for aggregating the at least one CC with the at least one additional CC by aggregating the UL subframes of the TDD carrier and an FDD UL carrier for communication on an UL with the second UE. The at least one FDD carrier includes the FDD UL carrier. The apparatus may further include means for aggregating the DL subframes and the UL subframes of the TDD carrier with the FDD UL carrier. The apparatus may further include means for aggregating the at least one CC with the at least one additional CC by aggregating the DL subframes of the TDD carrier and an FDD DL carrier for communication on a DL with the second UE. The at least one FDD carrier includes the FDD DL carrier. The apparatus may further include means for aggregating the UL subframes and the DL subframes of the TDD carrier with the FDD DL carrier. The apparatus may further include means for aggregating the at least one CC with the at least one additional CC by aggregating the first TDD UL subframes and the second TDD UL subframes for communication on an UL with the second UE. The apparatus may further include means for aggregating the first TDD UL subframes and the first TDD DL subframes with the second TDD UL subframes. The apparatus may further include means for aggregating the at least one CC with the at least one additional CC by aggregating the first TDD DL subframes and the second TDD DL subframes for communication on a DL with the second UE. The apparatus may further include means for aggregating the first TDD UL subframes and the first TDD DL subframes with the second TDD DL subframes. The apparatus may further include means for determining not to aggregate the at least one CC and the at least one additional CC for communication with the second UE when communication by the second UE on an UL through the at least one additional CC causes interference to the first UE that is greater than a first interference threshold and communication by the eNB on a DL through the at least one additional CC causes interference to the third UE that is greater than a second interference threshold. The apparatus may further include means for determining whether to communicate unidirectionally or bidirectionally with the second UE through the at least one additional CC. The apparatus may further include means for aggregating the at least one CC and the at least one additional CC for unidirectional communication with the second UE on an UL when the communication by the second UE on the UL through the at least one additional CC causes interference to the first UE that is less than a first interference threshold and communication by the eNB on a DL through the at least one additional CC causes interference to the third UE that is greater than a second interference threshold. The apparatus may further include means for aggregating the at least one CC and the at least one additional CC for unidirectional communication with the second UE on a DL when the communication by the second UE on an UL through the at least one additional CC causes interference to the first UE that is greater than a first interference threshold and the communication by the eNB on the DL through the at least one additional CC causes interference to the third UE that is less than a second interference threshold. The apparatus may further include means for aggregating the at least one CC and the at least one additional CC for bidirectional communication with the second UE on an UL and a DL when the communication by the second UE on the UL through the at least one additional CC causes interference to the first UE that is less than a first interference threshold and the communication by the eNB on the DL through the at least one additional CC causes interference to the third UE that is less than a second interference threshold. The aforementioned means may be one or more of the aforementioned modules 1602, 1604, 1606 of the apparatus 100′/100″ and/or the processing system 1714 of the apparatus 100″ configured to perform the functions recited by the aforementioned means. As described supra, the processing system 1714 may include the memory 342 and/or at least one of the TX processor 320, the RX processor 338, and the controller/processor 340. As such, in one configuration, the aforementioned means may be the TX processor 320, the RX processor 338, and the controller/processor 340 configured to perform the functions recited by the aforementioned means.

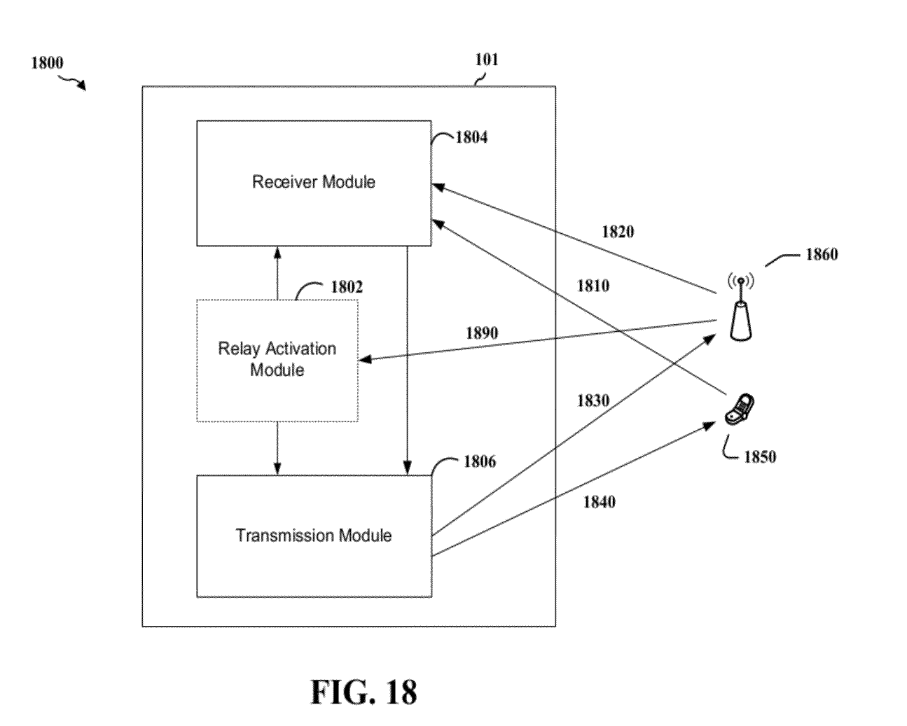

FIG. 18 is a conceptual data flow diagram 1800 illustrating the data flow between different modules/means/components in an exemplary UE apparatus 101. The apparatus may include a relay activation module 1802 that receives a relay activation 1890 from an eNB 1860. The apparatus includes a receiver module 1804 that receives DL communication 1820 from the eNB 1860 in DL through at least one CC. The apparatus further includes a transmission module 1806 that relays 1840 the DL communication to a UE 1850 in DL resources of at least one additional CC. The receiver module 1804 receives UL communication 1810 from the UE 1850 in UL resources of the at least one additional CC. The transmission module 1806 relays 1830 the UL communication to the eNB 1860 in UL through the at least one CC.

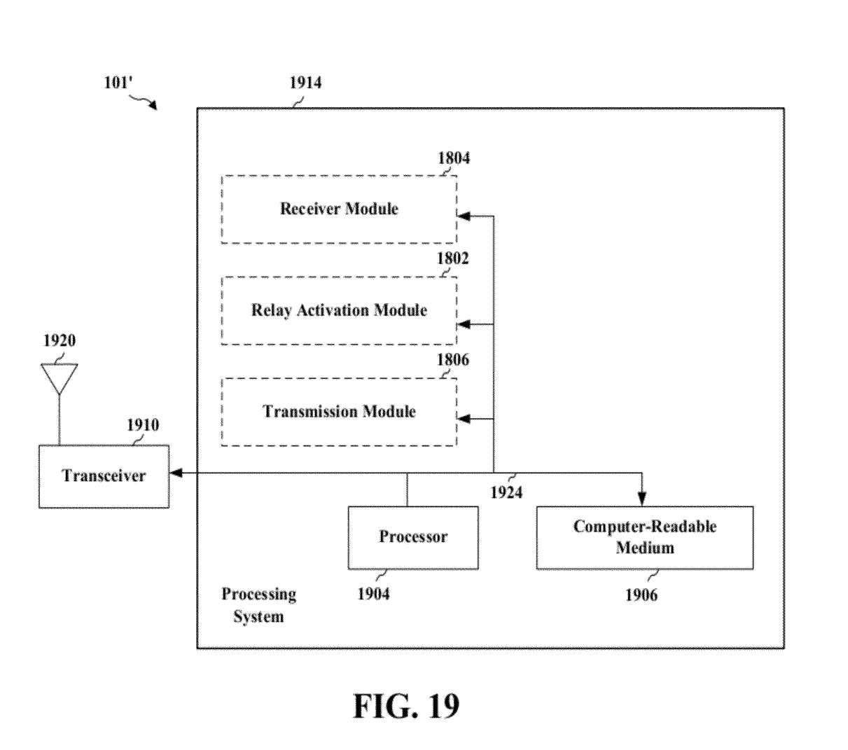

FIG. 19 is a diagram 1900 illustrating an example of a hardware implementation for an UE apparatus 100′ employing a processing system 1914. The processing system 1914 may be implemented with a bus architecture, represented generally by the bus 1924. The bus 1924 may include any number of interconnecting buses and bridges depending on the specific application of the processing system 1914 and the overall design constraints. The bus 1924 links together various circuits including one or more processors and/or hardware modules, represented by the processor 1904, the modules 1802, 1804, 1806 and the computer-readable medium 1906. The bus 1924 may also link various other circuits such as timing sources, peripherals, voltage regulators, and power management circuits, which are well known in the art, and therefore, will not be described any further. The apparatus includes a processing system 1914 coupled to a transceiver 1910. The transceiver 1910 is coupled to one or more antennas 1920. The transceiver 1910 provides a means for communicating with various other apparatus over a transmission medium. The processing system 1914 includes a processor 1904 coupled to a computer-readable medium 1906. The processor 1904 is responsible for general processing, including the execution of software stored on the computer-readable medium 1906. The software, when executed by the processor 1904, causes the processing system 1914 to perform the various functions described supra for any particular apparatus. The computer-readable medium 1906 may also be used for storing data that is manipulated by the processor 1904 when executing software. The processing system further includes modules 1802, 1804, 1806. The modules may be software modules running in the processor 1904, resident/stored in the computer readable medium 1906, one or more hardware modules coupled to the processor 1904, or some combination thereof. The processing system 1914 may be a component of the UE 120 and may include the memory 382 and/or at least one of the TX processor 364, the RX processor 358, and the controller/processor 380.

In one configuration, the apparatus 101/101′ for wireless communication includes means for receiving DL communication from an eNB in DL through at least one CC, means for relaying the DL communication to a UE in DL resources of at least one additional CC, means for receiving UL communication from the UE in UL resources of the at least one additional CC, and means for relaying the UL communication to the eNB in UL through the at least one CC. The apparatus may further include means for receiving a relay activation from the eNB. The aforementioned means may be one or more of the aforementioned modules 1802, 1804, 1806 of the apparatus 101/101′ and/or the processing system 1914 of the apparatus 101′ configured to perform the functions recited by the aforementioned means. As described supra, the processing system 1914 may include the memory 382 and/or at least one of the TX Processor 364, the RX Processor 358, and the controller/processor 380. As such, in one configuration, the aforementioned means may be the TX Processor 364, the RX Processor 358, and the controller/processor 380 configured to perform the functions recited by the aforementioned means.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication of a first base station (BS), comprising:
communicating with a first user equipment (UE) through at least one component carrier; and
determining whether to aggregate the at least one component carrier with at least one additional component carrier for communication with the first UE based on an interference caused to at least one of a second BS or a second UE, the at least one additional component carrier being used by the second BS to communicate with the second UE.

2. The method of claim 1, wherein the at least one component carrier comprises a frequency division duplex (FDD) uplink carrier and an FDD downlink carrier, and the at least one additional component carrier comprises at least one FDD carrier.

3. The method of claim 1, wherein the at least one component carrier comprises a frequency division duplex (FDD) uplink carrier and an FDD downlink carrier, and the at least one additional component carrier comprises a time division duplex (TDD) carrier.

4. The method of claim 1, wherein the at least one component carrier comprises a time division duplex (TDD) carrier comprising uplink subframes and downlink subframes and the at least one additional component carrier comprises at least one frequency division duplex (FDD) carrier.

5. The method of claim 1, wherein the at least one component carrier comprises a first time division duplex (TDD) carrier comprising first TDD uplink subframes and first TDD downlink subframes and the at least one additional component carrier comprises a second TDD carrier comprising second TDD uplink subframes and second TDD downlink subframes.

6. The method of claim 1, further comprising determining not to aggregate the at least on component carrier and the at least one additional component carrier for communication with the first UE when communication by the first UE on an uplink through the at least one additional component carrier causes interference to the second BS that is greater than a first interference threshold or communication by the first BS on a downlink through the at least one additional component carrier causes interference to the second UE that is greater than a second interference threshold.

7. The method of claim 1, further comprising determining whether to communicate unidirectionally or bidirectionally with the first UE through the at least one additional component carrier.

8. The method of claim 7, further comprising aggregating the at least one component carrier and the at least one additional component carrier for unidirectional communication with the first UE on an uplink when the communication by the first UE on the uplink through the at least one additional component carrier causes interference to the second BS that is less than a first interference threshold and communication by the first BS on a downlink through the at least one additional component carrier causes interference to the second UE that is greater than a second interference threshold.

9. The method of claim 7, further comprising aggregating the at least one component carrier and the at least one additional component carrier for unidirectional communication with the first UE on a downlink when the communication by the first UE on an uplink through the at least one additional component carrier causes interference to the second BS that is greater than a first interference threshold and the communication by the first BS on the downlink through the at least one additional component carrier causes interference to the second UE that is less than a second interference threshold.

10. The method of claim 7, further comprising aggregating the at least one component carrier and the at least one additional component carrier for bidirectional communication with the first UE on an uplink and a downlink when the communication by the first UE on the uplink through the at least one additional component carrier causes interference to the second BS that is less than a first interference threshold and the communication by the first BS on the downlink through the at least one additional component carrier causes interference to the second UE that is less than a second interference threshold.

11. A method of wireless communication, comprising:
receiving downlink communication from a base station (BS) in downlink through at least one component carrier;
relaying the downlink communication to a user equipment (UE) in resources of at least one additional component carrier;
receiving uplink communication from the UE in resources of the at least one additional component carrier; and
relaying the uplink communication to the BS in uplink through the at least one component carrier.

12. The method of claim 11, further comprising receiving a relay activation from the BS, wherein the method is performed by a first UE and the activation is based on at least one of a proximity detection between the UE and the first UE, an existing peer-to-peer communication between the UE and the first UE, or channel conditions of at least one of the UE or the first UE.

13. The method of claim 11, wherein:
the at least one component carrier comprises a frequency division duplex (FDD) uplink carrier and an FDD downlink carrier, and the at least one additional component carrier comprises a time division duplex (TDD) carrier comprising uplink and downlink subframes;
the at least one component carrier comprises a first FDD uplink carrier and a first FDD downlink carrier, and the at least one additional component carrier comprises a second FDD uplink carrier and a second FDD downlink carrier;
the at least one component carrier comprises a TDD carrier comprising uplink and downlink subframes, and the at least one additional component carrier comprises an FDD uplink carrier and an FDD downlink carrier; or
the at least one component carrier comprises a first TDD carrier comprising uplink and downlink subframes, and the at least one additional component carrier comprises a second TDD carrier comprising uplink and downlink subframes.

14. A method of wireless communication of a base station (BS), comprising:
communicating with a first user equipment (UE) through at least one component carrier;
communicating with a second UE through the at least one component carrier; and
determining whether to aggregate the at least one component carrier and at least one additional component carrier for communication with the second UE based on an interference caused to at least one of the first UE or a third UE, the at least one additional component carrier being used by the first UE to relay information between the third UE and the BS.

15. The method of claim 14, further comprising activating the first UE to act as a relay.

16. The method of claim 15, wherein the activation of the first UE to act as a relay for communication with the third UE is based on at least one of a proximity detection between the first UE and the third UE, an existing peer-to-peer communication between the first UE and the third UE, or channel conditions of at least one of the first UE or the third UE.

17. The method of claim 14, wherein the at least one component carrier comprises a frequency division duplex (FDD) uplink carrier and an FDD downlink carrier, and the at least one additional component carrier comprises at least one FDD carrier.

18. The method of claim 14, wherein the at least one component carrier comprises a frequency division duplex (FDD) uplink carrier and an FDD downlink carrier, and the at least one additional component carrier comprises a time division duplex (TDD) carrier comprising uplink subframes and downlink subframes.

19. The method of claim 14, wherein the at least one component carrier comprises a time division duplex (TDD) carrier comprising uplink subframes and downlink subframes and the at least one additional component carrier comprises at least one frequency division duplex (FDD) carrier.

20. The method of claim 14, wherein the at least one component carrier comprises a first time division duplex (TDD) carrier comprising first TDD uplink subframes and first TDD downlink subframes, and the at least one additional component carrier comprises a second TDD carrier comprising second TDD uplink subframes and second TDD downlink subframes.

21. The method of claim 14, further comprising determining not to aggregate the at least one component carrier and the at least one additional component carrier for communication with the second UE when communication by the second UE on an uplink through the at least one additional component carrier causes interference to the first UE that is greater than a first interference threshold and communication by the BS on a downlink through the at least one additional component carrier causes interference to the third UE that is greater than a second interference threshold.

22. The method of claim 14, further comprising determining whether to communicate unidirectionally or bidirectionally with the second UE through the at least one additional component carrier.

23. The method of claim 22, further comprising aggregating the at least one component carrier and the at least one additional component carrier for unidirectional communication with the second UE on an uplink when the communication by the second UE on the uplink through the at least one additional component carrier causes interference to the first UE that is less than a first interference threshold and communication by the BS on a downlink through the at least one additional component carrier causes interference to the third UE that is greater than a second interference threshold.

24. The method of claim 22, further comprising aggregating the at least one component carrier and the at least one additional component carrier for unidirectional communication with the second UE on a downlink when the communication by the second UE on an uplink through the at least one additional component carrier causes interference to the first UE that is greater than a first interference threshold and the communication by the BS on the downlink through the at least one additional component carrier causes interference to the third UE that is less than a second interference threshold.

25. The method of claim 22, further comprising aggregating the at least one component carrier and the at least one additional component carrier for bidirectional communication with the second UE on an uplink and a downlink when the communication by the second UE on the uplink through the at least one additional component carrier causes interference to the first UE that is less than a first interference threshold and the communication by the BS on the downlink through the at least one additional component carrier causes interference to the third UE that is less than a second interference threshold.

26. The method of claim 14, further comprising transmitting control information to the third UE through a component carrier, said component carrier being one of said at least one component carrier or a different component carrier, said component carrier being aggregated with said at least one additional component carrier by the third UE, wherein the information relayed by the first UE to the third UE is data from the BS.

27. A first base station (BS) for wireless communication, comprising:
means for communicating with a first user equipment (UE) through at least one component carrier; and
means for determining whether to aggregate the at least one component carrier with at least one additional component carrier for communication with the first UE based on an interference caused to at least one of a second BS or a second UE, the at least one additional component carrier being used by the second BS to communicate with the second UE.

28. The first BS of claim 27, wherein the at least one component carrier comprises a frequency division duplex (FDD) uplink carrier and an FDD downlink carrier, and the at least one additional component carrier comprises at least one FDD carrier.

29. The first BS of claim 27, wherein the at least one component carrier comprises a frequency division duplex (FDD) uplink carrier and an FDD downlink carrier, and the at least one additional component carrier comprises a time division duplex (TDD) carrier.

30. The first BS of claim 27, wherein the at least one component carrier comprises a time division duplex (TDD) carrier comprising uplink subframes and downlink subframes and the at least one additional component carrier comprises at least one frequency division duplex (FDD) carrier.

31. The first BS of claim 27, wherein the at least one component carrier comprises a first time division duplex (TDD) carrier comprising first TDD uplink subframes and first TDD downlink subframes and the at least one additional component carrier comprises a second TDD carrier comprising second TDD uplink subframes and second TDD downlink subframes.

32. The first BS of claim 27, further comprising means for determining not to aggregate the at least on component carrier and the at least one additional component carrier for communication with the first UE when communication by the first UE on an uplink through the at least one additional component carrier causes interference to the second BS that is greater than a first interference threshold or communication by the first BS on a downlink through the at least one additional component carrier causes interference to the second UE that is greater than a second interference threshold.

33. The first BS of claim 27, further comprising means for determining whether to communicate unidirectionally or bidirectionally with the first UE through the at least one additional component carrier.

34. The first BS of claim 33, further comprising means for aggregating the at least one component carrier and the at least one additional component carrier for unidirectional communication with the first UE on an uplink when the communication by the first UE on the uplink through the at least one additional component carrier causes interference to the second BS that is less than a first interference threshold and communication by the first BS on a downlink through the at least one additional component carrier causes interference to the second UE that is greater than a second interference threshold.

35. The first BS of claim 33, further comprising means for aggregating the at least one component carrier and the at least one additional component carrier for unidirectional communication with the first UE on a downlink when the communication by the first UE on an uplink through the at least one additional component carrier causes interference to the second BS that is greater than a first interference threshold and the communication by the first BS on the downlink through the at least one additional component carrier causes interference to the second UE that is less than a second interference threshold.

36. The first BS of claim 33, further comprising means for aggregating the at least one component carrier and the at least one additional component carrier for bidirectional communication with the first UE on an uplink and a downlink when the communication by the first UE on the uplink through the at least one additional component carrier causes interference to the second BS that is less than a first interference threshold and the communication by the first BS on the downlink through the at least one additional component carrier causes interference to the second UE that is less than a second interference threshold.

37. An apparatus for wireless communication, comprising:
means for receiving downlink communication from a base station (BS) in downlink through at least one component carrier;
means for relaying the downlink communication to a user equipment (UE) in resources of at least one additional component carrier;
means for receiving uplink communication from the UE in resources of the at least one additional component carrier; and
means for relaying the uplink communication to the BS in uplink through the at least one component carrier.

38. The apparatus of claim 37, further comprising means for receiving a relay activation from the BS, wherein the activation is based on at least one of a proximity detection between the UE and the apparatus, an existing peer-to-peer communication between the UE and the apparatus, or channel conditions of at least one of the UE or the apparatus.

39. The apparatus of claim 37, wherein:
the at least one component carrier comprises a frequency division duplex (FDD) uplink carrier and an FDD downlink carrier, and the at least one additional component carrier comprises a time division duplex (TDD) carrier comprising uplink and downlink subframes;
the at least one component carrier comprises a first FDD uplink carrier and a first FDD downlink carrier, and the at least one additional component carrier comprises a second FDD uplink carrier and a second FDD downlink carrier;
the at least one component carrier comprises a TDD carrier comprising uplink and downlink subframes, and the at least one additional component carrier comprises an FDD uplink carrier and an FDD downlink carrier; or
the at least one component carrier comprises a first TDD carrier comprising uplink and downlink subframes, and the at least one additional component carrier comprises a second TDD carrier comprising uplink and downlink subframes.

40. A base station (BS) for wireless communication, comprising:
means for communicating with a first user equipment (UE) through at least one component carrier;
means for communicating with a second UE through the at least one component carrier; and
means for determining whether to aggregate the at least one component carrier and at least one additional component carrier for communication with the second UE based on an interference caused to at least one of the first UE or a third UE, the at least one additional component carrier being used by the first UE to relay information between the third UE and the BS.

41. The BS of claim 40, further comprising means for activating the first UE to act as a relay.

42. The BS of claim 41, wherein the activation of the first UE to act as a relay for communication with the third UE is based on at least one of a proximity detection between the first UE and the third UE, an existing peer-to-peer communication between the first UE and the third UE, or channel conditions of at least one of the first UE or the third UE.

43. The BS of claim 40, wherein the at least one component carrier comprises a frequency division duplex (FDD) uplink carrier and an FDD downlink carrier, and the at least one additional component carrier comprises at least one FDD carrier.

44. The BS of claim 40, wherein the at least one component carrier comprises a frequency division duplex (FDD) uplink carrier and an FDD downlink carrier, and the at least one additional component carrier comprises a time division duplex (TDD) carrier comprising uplink subframes and downlink subframes.

45. The BS of claim 40, wherein the at least one component carrier comprises a time division duplex (TDD) carrier comprising uplink subframes and downlink subframes and the at least one additional component carrier comprises at least one frequency division duplex (FDD) carrier.

46. The BS of claim 40, wherein the at least one component carrier comprises a first time division duplex (TDD) carrier comprising first TDD uplink subframes and first TDD downlink subframes, and the at least one additional component carrier comprises a second TDD carrier comprising second TDD uplink subframes and second TDD downlink subframes.

47. The BS of claim 40, further comprising means for determining not to aggregate the at least one component carrier and the at least one additional component carrier for communication with the second UE when communication by the second UE on an uplink through the at least one additional component carrier causes interference to the first UE that is greater than a first interference threshold and communication by the BS on a downlink through the at least one additional component carrier causes interference to the third UE that is greater than a second interference threshold.

48. The BS of claim 40, further comprising means for determining whether to communicate unidirectionally or bidirectionally with the second UE through the at least one additional component carrier.

49. The BS of claim 48, further comprising means for aggregating the at least one component carrier and the at least one additional component carrier for unidirectional communication with the second UE on an uplink when the communication by the second UE on the uplink through the at least one additional component carrier causes interference to the first UE that is less than a first interference threshold and communication by the BS on a downlink through the at least one additional component carrier causes interference to the third UE that is greater than a second interference threshold.

50. The BS of claim 48, further comprising means for aggregating the at least one component carrier and the at least one additional component carrier for unidirectional communication with the second UE on a downlink when the communication by the second UE on an uplink through the at least one additional component carrier causes interference to the first UE that is greater than a first interference threshold and the communication by the BS on the downlink through the at least one additional component carrier causes interference to the third UE that is less than a second interference threshold.

51. The BS of claim 48, further comprising means for aggregating the at least one component carrier and the at least one additional component carrier for bidirectional communication with the second UE on an uplink and a downlink when the communication by the second UE on the uplink through the at least one additional component carrier causes interference to the first UE that is less than a first interference threshold and the communication by the BS on the downlink through the at least one additional component carrier causes interference to the third UE that is less than a second interference threshold.

52. The BS of claim 40, further comprising means for transmitting control information to the third UE through a component carrier, said component carrier being one of said at least one component carrier or a different component carrier, said component carrier being aggregated with said at least one additional component carrier by the third UE, wherein the information relayed by the first UE to the third UE is data from the BS.

53. A first base station (BS) for wireless communication, comprising:
a processing system configured to:
communicate with a first user equipment (UE) through at least one component carrier; and
determine whether to aggregate the at least one component carrier with at least one additional component carrier for communication with the first UE based on an interference caused to at least one of a second BS or a second UE, the at least one additional component carrier being used by the second BS to communicate with the second UE.

54. The first BS of claim 53, wherein the at least one component carrier comprises a frequency division duplex (FDD) uplink carrier and an FDD downlink carrier, and the at least one additional component carrier comprises at least one FDD carrier.

55. The first BS of claim 53, wherein the at least one component carrier comprises a frequency division duplex (FDD) uplink carrier and an FDD downlink carrier, and the at least one additional component carrier comprises a time division duplex (TDD) carrier.

56. The first BS of claim 53, wherein the at least one component carrier comprises a time division duplex (TDD) carrier comprising uplink subframes and downlink subframes and the at least one additional component carrier comprises at least one frequency division duplex (FDD) carrier.

57. The first BS of claim 53, wherein the at least one component carrier comprises a first time division duplex (TDD) carrier comprising first TDD uplink subframes and first TDD downlink subframes and the at least one additional component carrier comprises a second TDD carrier comprising second TDD uplink subframes and second TDD downlink subframes.

58. The first BS of claim 53, wherein the processing system is further configured to determine not to aggregate the at least on component carrier and the at least one additional component carrier for communication with the first UE when communication by the first UE on an uplink through the at least one additional component carrier causes interference to the second BS that is greater than a first interference threshold or communication by the first BS on a downlink through the at least one additional component carrier causes interference to the second UE that is greater than a second interference threshold.

59. The first BS of claim 53, wherein the processing system is further configured to determine whether to communicate unidirectionally or bidirectionally with the first UE through the at least one additional component carrier.

60. The first BS of claim 59, wherein the processing system is further configured to aggregate the at least one component carrier and the at least one additional component carrier for unidirectional communication with the first UE on an uplink when the communication by the first UE on the uplink through the at least one additional component carrier causes interference to the second BS that is less than a first interference threshold and communication by the first BS on a downlink through the at least one additional component carrier causes interference to the second UE that is greater than a second interference threshold.

61. The first BS of claim 59, wherein the processing system is further configured to aggregate the at least one component carrier and the at least one additional component carrier for unidirectional communication with the first UE on a downlink when the communication by the first UE on an uplink through the at least one additional component carrier causes interference to the second BS that is greater than a first interference threshold and the communication by the first BS on the downlink through the at least one additional component carrier causes interference to the second UE that is less than a second interference threshold.

62. The first BS of claim 59, wherein the processing system is further configured to aggregate the at least one component carrier and the at least one additional component carrier for bidirectional communication with the first UE on an uplink and a downlink when the communication by the first UE on the uplink through the at least one additional component carrier causes interference to the second BS that is less than a first interference threshold and the communication by the first BS on the downlink through the at least one additional component carrier causes interference to the second UE that is less than a second interference threshold.

63. An apparatus for wireless communication, comprising:
a processing system configured to:
receive downlink communication from a base station (BS) in downlink through at least one component carrier;
relay the downlink communication to a user equipment (UE) in resources of at least one additional component carrier;
receive uplink communication from the UE in resources of the at least one additional component carrier; and
relay the uplink communication to the BS in uplink through the at least one component carrier.

64. The apparatus of claim 63, wherein the processing system is further configured to receive a relay activation from the BS, wherein the activation is based on at least one of a proximity detection between the UE and the apparatus, an existing peer-to-peer communication between the UE and the apparatus, or channel conditions of at least one of the UE or the apparatus.

65. The apparatus of claim 63, wherein:
the at least one component carrier comprises a frequency division duplex (FDD) uplink carrier and an FDD downlink carrier, and the at least one additional component carrier comprises a time division duplex (TDD) carrier comprising uplink and downlink sub frames;
the at least one component carrier comprises a first FDD uplink carrier and a first FDD downlink carrier, and the at least one additional component carrier comprises a second FDD uplink carrier and a second FDD downlink carrier;
the at least one component carrier comprises a TDD carrier comprising uplink and downlink subframes, and the at least one additional component carrier comprises an FDD uplink carrier and an FDD downlink carrier; or
the at least one component carrier comprises a first TDD carrier comprising uplink and downlink subframes, and the at least one additional component carrier comprises a second TDD carrier comprising uplink and downlink subframes.

66. A base station (BS) for wireless communication, comprising:
a processing system configured to:
communicate with a first user equipment (UE) through at least one component carrier;
communicate with a second UE through the at least one component carrier; and
determine whether to aggregate the at least one component carrier and at least one additional component carrier for communication with the second UE based on an interference caused to at least one of the first UE or a third UE, the at least one additional component carrier being used by the first UE to relay information between the third UE and the BS.

67. The BS of claim 66, wherein the processing system is further configured to activate the first UE to act as a relay.

68. The BS of claim 67, wherein the activation of the first UE to act as a relay for communication with the third UE is based on at least one of a proximity detection between the first UE and the third UE, an existing peer-to-peer communication between the first UE and the third UE, or channel conditions of at least one of the first UE or the third UE.

69. The BS of claim 66, wherein the at least one component carrier comprises a frequency division duplex (FDD) uplink carrier and an FDD downlink carrier, and the at least one additional component carrier comprises at least one FDD carrier.

70. The BS of claim 66, wherein the at least one component carrier comprises a frequency division duplex (FDD) uplink carrier and an FDD downlink carrier, and the at least one additional component carrier comprises a time division duplex (TDD) carrier comprising uplink subframes and downlink subframes.

71. The BS of claim 66, wherein the at least one component carrier comprises a time division duplex (TDD) carrier comprising uplink subframes and downlink subframes and the at least one additional component carrier comprises at least one frequency division duplex (FDD) carrier.

72. The BS of claim 66, wherein the at least one component carrier comprises a first time division duplex (TDD) carrier comprising first TDD uplink subframes and first TDD downlink subframes, and the at least one additional component carrier comprises a second TDD carrier comprising second TDD uplink subframes and second TDD downlink subframes.

73. The BS of claim 66, wherein the processing system is further configured to determine not to aggregate the at least one component carrier and the at least one additional component carrier for communication with the second UE when communication by the second UE on an uplink through the at least one additional component carrier causes interference to the first UE that is greater than a first interference threshold and communication by the BS on a downlink through the at least one additional component carrier causes interference to the third UE that is greater than a second interference threshold.

74. The BS of claim 66, wherein the processing system is further configured to determine whether to communicate unidirectionally or bidirectionally with the second UE through the at least one additional component carrier.

75. The BS of claim 74, wherein the processing system is further configured to aggregate the at least one component carrier and the at least one additional component carrier for unidirectional communication with the second UE on an uplink when the communication by the second UE on the uplink through the at least one additional component carrier causes interference to the first UE that is less than a first interference threshold and communication by the BS on a downlink through the at least one additional component carrier causes interference to the third UE that is greater than a second interference threshold.

76. The BS of claim 74, wherein the processing system is further configured to aggregate the at least one component carrier and the at least one additional component carrier for unidirectional communication with the second UE on a downlink when the communication by the second UE on an uplink through the at least one additional component carrier causes interference to the first UE that is greater than a first interference threshold and the communication by the BS on the downlink through the at least one additional component carrier causes interference to the third UE that is less than a second interference threshold.

77. The BS of claim 74, wherein the processing system is further configured to aggregate the at least one component carrier and the at least one additional component carrier for bidirectional communication with the second UE on an uplink and a downlink when the communication by the second UE on the uplink through the at least one additional component carrier causes interference to the first UE that is less than a first interference threshold and the communication by the BS on the downlink through the at least one additional component carrier causes interference to the third UE that is less than a second interference threshold.

78. The BS of claim 66, wherein the processing system is further configured to transmit control information to the third UE through a component carrier, said component carrier being one of said at least one component carrier or a different component carrier, said component carrier being aggregated with said at least one additional component carrier by the third UE, wherein the information relayed by the first UE to the third UE is data from the BS.

79. A computer program product in a first base station (BS), comprising:
a computer-readable medium comprising code for:
communicating with a first user equipment (UE) through at least one component carrier; and
determining whether to aggregate the at least one component carrier with at least one additional component carrier for communication with the first UE based on an interference caused to at least one of a second BS or a second UE, the at least one additional component carrier being used by the second BS to communicate with the second UE.

80. A computer program product, comprising:
a computer-readable medium comprising code for:
receiving downlink communication from a base station (BS) in downlink through at least one component carrier;
relaying the downlink communication to a user equipment (UE) in resources of at least one additional component carrier;
receiving uplink communication from the UE in resources of the at least one additional component carrier; and
relaying the uplink communication to the BS in uplink through the at least one component carrier.

81. A computer program product in a base station (BS), comprising:
a computer-readable medium comprising code for:
communicating with a first user equipment (UE) through at least one component carrier;
communicating with a second UE through the at least one component carrier; and
determining whether to aggregate the at least one component carrier and at least one additional component carrier for communication with the second UE based on an interference caused to at least one of the first UE or a third UE, the at least one additional component carrier being used by the first UE to relay information between the third UE and the BS.
